(19) United States
(12) Patent Application Publication
(10) Pub. No.: US 2020/0084683 A1
(43) Pub. Date: Mar. 12, 2020

(54) Target Link Ranking in a Wireless Communication Network

(71) Applicant: Telefonaktiebolaget LM Ericsson (publ), Stockholm (SE)

(72) Inventors: Reza Moosavi, Linköping (SE); Sakib bin Redhwan, Linköping (SE); Icaro L. J. da Silva, Solna (SE); Pradeepa Ramachandra, Linköping (SE)

(21) Appl. No.: 16/326,736

(22) PCT Filed: Nov. 8, 2018
(86) PCT No.: PCT/SE2018/051140

§ 371 Date: Feb. 20, 2019

Related U.S. Application Data
(60) Provisional application No. 62/587,222, filed on Nov. 16, 2017.

(51) Int. Cl. H04W 36/06; H04W 36/00; H04W 36/38; H04W 36/24

(52) U.S. Cl. CPC H04W 36/06; H04W 36/24; H04W 36/38; H04W 36/0072

(57) ABSTRACT

A wireless device (16) is configured for use in a wireless communication network (10). The wireless device (16) is configured to receive, from network equipment (18), signaling that indicates a ranking (26) of target links (20) to which the wireless device (16) is commanded to conditionally perform a link switch (24). If the wireless device (16) detects, for each of one or more of the target links (20), fulfillment of a condition for performing a link switch (24) to that target link, the wireless device (16) may attempt to perform a link switch (24) to at least some of the one or more target links (20) for which the condition has been fulfilled, in order of the indicated ranking (26).

### TECHNICAL FIELD

The present application relates generally to a wireless communication network, and relates more particularly to ranking of target links for a link switch in such a network.

### BACKGROUND

One of the main goals of New Radio (NR) is to provide more capacity for operators to serve ever-increasing traffic demands and varieties of applications. Because of this, NR will be able to operate on high frequencies like frequencies over 6 GHz up to 60 GHz or even 100 GHz.

In comparison to the current frequency bands allocated to Long Term Evolution (LTE), some of the new bands will have much more challenging propagation properties such as lower diffraction and higher outdoor/indoor penetration losses. As a consequence, signals will have less ability to propagate around corners and penetrate walls. In addition, in high frequency bands, atmospheric/rain attenuation and higher body losses render the coverage of NR signals even more spotty.

Fortunately, the operation in higher frequencies makes it possible to use smaller antenna elements, which enables antenna arrays with many antenna elements. Such antenna arrays facilitate beamforming, where multiple antenna elements are used to form narrow beams and thereby compensate for the challenging propagation properties.

Despite the link budget gains provided by beamforming solutions, reliability of a system purely relying on beamforming and operating in higher frequencies might be challenging, since the coverage might be more sensitive to both time and space variations. As a consequence of that, the signal to interference plus noise ratio (SINR) of such a narrow link can drop much quicker than in the case of LTE.

Already in LTE, it has been observed that the serving link may not be able to convey the handover command timely. Lowering the time-to-transmit (TTT) and the measurement hysteresis allowed to reduce the handover failure rate but also resulted in higher ping-pong probability. It is expected that, in NR, these effects will be even more pronounced when operating at higher frequency bands. Because of these aspects, there is need to put attention to mobility robustness in NR systems.

One solution is called “early handover command” or “conditional handover command”. In order to avoid the undesired dependence on the serving radio link upon the time (and radio conditions) where the user equipment (UE) should execute the handover (HO), NR should offer the possibility to provide radio resource control (RRC) signaling for the handover to the UE earlier. To achieve this, it should be possible to associate the HO command with a condition. As soon as the condition is fulfilled, the UE may execute the handover in accordance with the provided handover command.

In this way, the network effectively allows the UE to decide when to execute the handover. Although this improves mobility robustness in the face of fast fading on the source link, it jeopardizes the ability of the network to maintain control over the UE, e.g. in order to optimize network performance. This proves true especially if, for instance, the network were to issue conditional handover commands for multiple target links to which the UE may choose to handover.

### SUMMARY

According to some embodiments herein, a wireless communication network may indicate to a wireless device multiple target links that are candidates for the wireless device to access the network with, yet still maintain some control over which of the target links the wireless device uses to access the network. Rather than letting the wireless device autonomously choose from among the multiple target links without qualification, the network in some embodiments indicates, dictates, or otherwise imposes a ranking of the targets links to govern which of the target links the wireless device preferentially uses to access the network. Such ranking may effectively indicate or define an order in which the target links are preferred, e.g., by the network, for the wireless device to use for accessing the network. For example, in a link switch, e.g., handover, context, the wireless device may attempt to perform a link switch to one or more of the target links in order of the ranking of the target links. Regardless, preserving at least some network control over target link access by the wireless device may advantageously enable the network to prepare link switch decisions more effectively and efficiently, while still ensuring mobility robustness.

More particularly, embodiments herein include a method performed by a wireless device configured for use in a wireless communication network. The method comprises receiving, from network equipment, signaling that indicates a ranking of target links to which the wireless device is commanded to conditionally perform a link switch.

In some embodiments, the method further comprises, responsive to detecting fulfillment of one or more conditions for performing a link switch to any of certain ones of the target links, attempting to perform a link switch to one or more of the certain target links in order of the indicated ranking.

In some embodiments, for each of the target links, the wireless device is commanded to perform a link switch to the target link upon the fulfillment of a respective condition. In this case, the method in some embodiments further comprises, for each of one or more of the target links, detecting fulfillment of the condition for performing a link switch to that target link. The method may also comprise attempting to perform a link switch to at least some of the one or more target links for which the condition has been fulfilled, in order of the indicated ranking.

In some embodiments, the attempting to perform a link switch comprises attempting to perform a link switch to a lower ranked target link only after an attempt to perform a link switch to a higher ranked target link has failed. In other embodiments, the attempting to perform a link switch comprises attempting to perform a link switch to a lower ranked target link after attempting to perform a link switch to a higher ranked target link, but before that attempt to perform a link switch to the higher ranked target link is deemed to have succeeded or failed.

In some embodiments, the method further comprises receiving multiple radio resource control, RRC, connection reconfiguration messages for respective target links, wherein the RRC connection reconfiguration message received for a respective target link commands the wireless device to perform a link switch to the target link upon fulfillment of a respective condition. Or, in some embodiments, the method further comprises receiving one RRC connection reconfiguration message for the target links, wherein the one RRC connection reconfiguration message commands the wireless device to perform a link switch to any of the target links for which the same condition is fulfilled.

In some embodiments, the method further comprises transmitting, to the network equipment, a measurement report for each of the target links, and wherein the signaling is received after said transmitting.

Embodiments herein also include a method performed by network equipment configured for use in a wireless communication network. The method comprises transmitting to a wireless device signaling that indicates a ranking of target links to which the wireless device is commanded to conditionally perform a link switch.

In some embodiments, the method further comprises, responsive to receiving a measurement report from the wireless device, determining a set of target links to evaluate as candidates for commanding the wireless device to conditionally perform a link switch; determining a ranking of the target links in the set; deciding, based on the determined ranking, to which of the target links in the set the network equipment is to command the wireless device to conditionally perform a link switch; and transmitting to the wireless device signaling, in accordance with said deciding, indicating target links to which the wireless device is commanded to conditionally perform a link switch.

In some embodiments, the method further comprises, before determining the ranking of the target links in the set, preparing each of the target links in the set for the link switch by transmitting a link switch request to each of one or more network equipment providing the target links; and after said deciding based on the determined ranking, transmitting release signaling to any network equipment providing a target link to which the wireless device is not to be commanded to perform a conditional link switch, the release signaling indicating to release any resources prepared for a link switch to the target link.

In one such embodiment, the method further comprises determining the ranking of the target links in the set based, at least in part, on information received from each of the one or more network equipment in response to the link switch request transmitted to that network equipment. In one embodiment, the information received from each of the one or more network equipment includes information about resources prepared for a link switch to a target link provided by that network equipment.

In any of these embodiments, the method may comprise determining the ranking of the target links based on one or more of: for each of one or more of the target links, a rank of the target link received from network equipment providing that target link; current or expected loading on each of the target links; a type or coverage area size of each of the target links; statistics describing historical success or failure of link switches to each of the target links; a type of random access resources provided by each of the target links; and a validity timer of resources provided by each of the target links.

In any of these embodiments, the signaling indicating the ranking of the target links to which the wireless device is commanded to conditionally perform a link switch may comprise signaling indicating a ranking of a set of potential target links and signaling indicating which of the potential target links are target links to which the wireless device is commanded to conditionally perform a link switch.

In any others of these embodiments, the signalling may implicitly indicate the ranking of target links by indicating a list of target links, with the target links ordered in the list according to the ranking.

In any others of these embodiments, the signalling may explicitly indicate the ranking of target links by indicating a list of target links and indicating a rank for each target link in the list.

In any of these embodiments, the link switch may be a conditional handover that is to be performed upon the wireless device detecting fulfilment of one or more conditions.

Embodiments also include corresponding apparatus, computer programs, and carriers, e.g., non-transitory computer-readable mediums. For example, embodiments herein include a wireless device configured for use in a wireless communication network. The wireless device is configured, e.g., via communication circuitry and processing circuitry, to receive from network equipment signaling that indicates a ranking of target links to which the wireless device is commanded to conditionally perform a link switch.

Embodiments also include network equipment configured for use in a wireless communication network. The network equipment is configured, e.g., via communication circuitry and processing circuitry, to transmit to a wireless device signaling that indicates a ranking of target links to which the wireless device is commanded to conditionally perform a link switch.

### BRIEF DESCRIPTION OF THE DRAWINGS

FIG. 1 is block diagram of a wireless communication network according to one or more embodiments.

FIG. 2A is a call flow diagram of a process for determining and signaling to a wireless device a ranking of target links according to some embodiments.

FIG. 2B is a call flow diagram of a process for determining and signaling to a wireless device a ranking of target links according to other embodiments.

FIG. 2C is a call flow diagram of a process for a wireless device to determine a ranking of target links according to some embodiments.

FIG. 2D is a call flow diagram of a process for target network equipment to allocate resources on a target link according to a rank of the target link, according to some embodiments.

FIG. 3 is a logic flow diagram of a method performed by a wireless device according to some embodiments.

FIG. 4 is a logic flow diagram of a method performed by network equipment according to some embodiments.

FIG. 5 is a logic flow diagram of a method performed by a wireless device according to other embodiments.

FIG. 6 is a logic flow diagram of a method performed by network equipment according to other embodiments.

FIG. 7 is a logic flow diagram of a method performed by source network equipment according to some embodiments.

FIG. 8 is a logic flow diagram of a method performed by target network equipment according to some embodiments.

FIG. 9 is a logic flow diagram of a method performed by target network equipment according to other embodiments.

FIG. 10 is a logic flow diagram of a method performed by source network equipment according to other embodiments.

FIG. 11 is a block diagram of a wireless device according to some embodiments.

FIG. 12 is a block diagram of a wireless device according to other embodiments.

FIG. 13 is a block diagram of network equipment according to some embodiments.

FIG. 14 is a block diagram of network equipment according to other embodiments.

FIG. 15 is a block diagram of network equipment according to still other embodiments.

FIG. 16 is a call flow diagram of a process for conditional handover according to some embodiments.

FIG. 17 is a block diagram of a wireless communication network according to some embodiments.

FIG. 18 is a block diagram of a user equipment according to some embodiments.

FIG. 19 is a block diagram of a virtualization environment according to some embodiments.

FIG. 20 is a block diagram of a communication network with a host computer according to some embodiments.

FIG. 21 is a block diagram of a host computer according to some embodiments.

FIG. 22 is a flowchart illustrating a method implemented in a communication system, in accordance with one embodiment.

FIG. 23 is a flowchart illustrating a method implemented in a communication system, in accordance with one embodiment.

FIG. 24 is a flowchart illustrating a method implemented in a communication system, in accordance with one embodiment.

FIG. 25 is a flowchart illustrating a method implemented in a communication system, in accordance with one embodiment.

### DETAILED DESCRIPTION

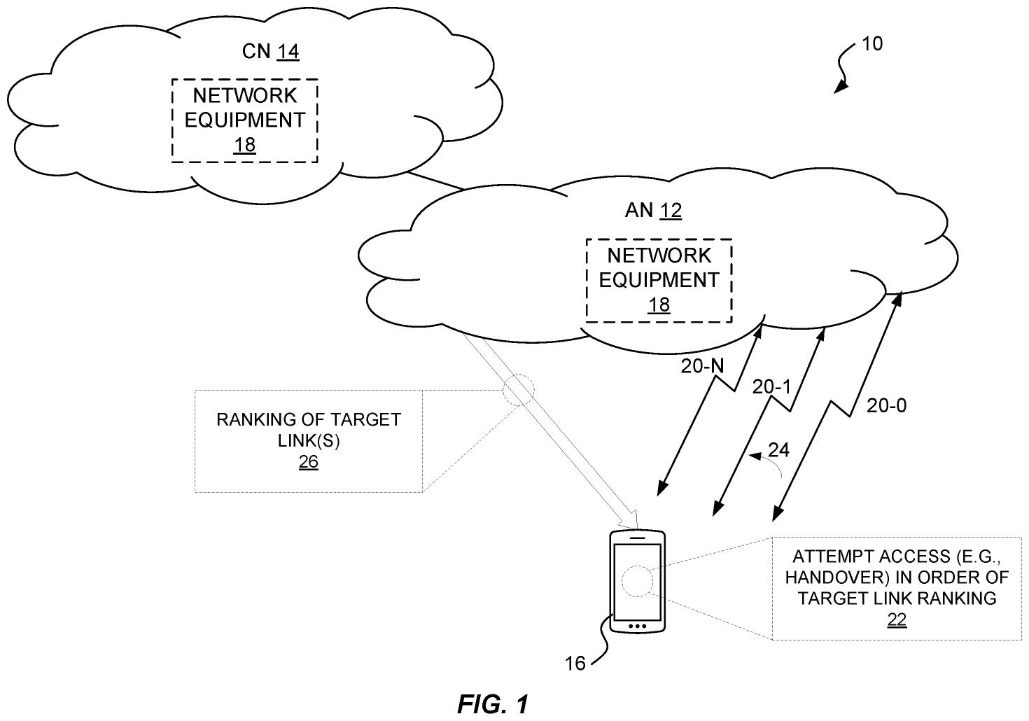

FIG. 1 illustrates a wireless communication network 10 according to one or more embodiments. As shown, the network 10, e.g., a 5G network or New Radio, NR, network, may include an access network (AN) 12 and a core network (CN) 14. The AN 12 wirelessly connects a wireless communication device 16 (or simply “wireless device 16”) to the CN 14. The CN 14 in turn connects the wireless device 16 to one or more external networks (not shown), such as a public switched telephone network and/or a packet data network, e.g., the Internet.

The AN 12 provides links via which the wireless device 16 may wirelessly access the system 10, e.g., using uplink and/or downlink communications. The AN 12 may for example provide links 20-0, 20-1, . . . 20-N (generally links 20) in the form of access nodes, e.g., base stations, cells, sectors, beams, or the like. Some links 20 may provide wireless coverage over different geographical areas.

The network 10, e.g., via one or more network equipment 18 in the AN 12 and/or CN 14, controls which link 20 the device 16 uses to access the network 10, e.g., in or for a so-called connected mode (which may for instance be a mode in which the device 16 has established a radio resource control, RRC, connection with the network 10, in contrast with an RRC idle mode in which no RRC connection is established. The network 10 in this regard may control with which link 20 the device 16 accesses the network 10 using dual connectivity, carrier aggregation, or the like. Alternatively or additionally, the network 10 may control to which link 20 the device 16 switches for accessing the network 10. More particularly with regard to this latter case, the network 10 may control which link 20 the device 16 uses by for example deciding that the device 16 is to switch 24 from accessing the system 10 via one link to accessing the system 10 via another link in connected mode. In some embodiments, for example, this link switch 24 may be a handover. The link switch 24 may be unconditional or conditional. When the device 16 is commanded to conditionally perform a link switch 24, for instance, the device 16 is to autonomously perform that link switch 24 responsive to fulfillment of a condition, e.g., responsive to the device 16 detecting that the target link's signal strength or quality exceeds that of the source link by at least a defined amount. The network 10 may command the wireless device 16 to conditionally perform the link switch 24 by for example transmitting to the wireless device 16 a link switch command, e.g., in the form of an RRC connection reconfiguration message with a mobility control information element, that includes or is otherwise associated with a condition for performing a link switch to a target link. Conditionally performing the link switch 24 in this or other ways may for instance improve the robustness of the link switch 24 against deteriorating source link conditions.

According to some embodiments herein, though, the network 10 indicates to the wireless device 16 multiple target links that are candidates for the wireless device 16 to access the network 10 with, i.e., multiple links that are targets for the wireless device 16 to attempt access with. For example, the network 10 may indicate multiple target links 20 from which the wireless device 16 may choose to use for accessing the network 10 using dual connectivity, carrier aggregation. Alternatively, the network 10 may indicate multiple target links 20 that are candidates for the wireless device to switch to accessing via a link switch to be performed in the connected mode, e.g., by transmitting one or more handover commands to the wireless device 16 indicating multiple target links 20 of the handover.

In some embodiments, for example, the network 10 may transmit multiple radio resource control (RRC) connection reconfiguration messages for respective target links 20, i.e., one RRC connection reconfiguration message per target link. The RRC reconfiguration message for a respective target link. e.g., by way of the message's inclusion of a mobility control information element, may command the wireless device 16 to perform a link switch to the target link upon fulfillment of a respective condition. The condition may for instance be specified in the RRC reconfiguration message or be otherwise associated with the RRC reconfiguration message. In this embodiment, then, the conditions for performing a link switch to different target links may be specified separately so as to allow for different conditions for different target links.

In other embodiments, the network 10 may transmit a single RRC connection reconfiguration message for the target links 20, i.e., only one RRC connection reconfiguration message across all of the target links 20. The RRC connection reconfiguration message in this case may command the wireless device 10 to perform a link switch to any of the target links 20 for which the same condition is fulfilled. The condition may for instance be specified in the RRC reconfiguration message or be otherwise associated with the RRC reconfiguration message. In this embodiment, then, the condition for performing a link switch to different target links is necessarily the same.

Despite indicating multiple target links to the wireless device 16, in any number of possible ways, the network 10 in some embodiments still maintains some control over which of the target links the wireless device 16 uses to access the network 10. Rather than letting the wireless device 16 autonomously choose from among the multiple target links without qualification, the network 10 in some embodiments indicates, dictates, or otherwise imposes a ranking of the targets links to govern which of the target links the wireless device 16 preferentially uses to access the network 10. Such ranking may effectively indicate or define an order in which the target links are preferred, e.g., by the network 10, for the wireless device 16 to use for accessing the network 10.

As shown in FIG. 1, for instance, the network 10 may explicitly signal a ranking 26 of target links to the wireless device 16, e.g., in or in association with one or more commands to perform a link switch. In other embodiments, by contrast, the wireless device 16 may itself determine the ranking of target cells, e.g., according to one or more rules imposed by the network 10 on the wireless device 16 and/or based on information received from the network 10.

In either case, the device 16 herein may, in connected mode, attempt 22 to access one or more target links 20 in order of the ranking of multiple target links that are candidates for the device 16 to access. For example, in a link switch, e.g., handover, context, the wireless device 16 may attempt to perform a link switch to one or more of the target links, namely, those for which the conditions are fulfilled for performing a link switch to, in order of the ranking of the target links. More particularly in this regard, the network 10 may command the wireless device to perform a link switch to each of the target links 20 upon the fulfillment of a respective condition. When the wireless device 16 detects, for each of one or more of the target links 20, fulfillment of the condition for performing a link switch to that target link, the wireless device 16 may then attempt to perform a link switch to at least some of the one or more target links for which the condition has been fulfilled, in order of the ranking.

In some embodiments, the device 16 may attempt to access a lower ranked target link only after an attempt to access a higher ranked target link has failed. In this case, if the device 16 succeeds in its attempt to access the higher ranked target link whose condition has been fulfilled, then the device 16 may refrain from attempting to access the lower ranked target link, even if the condition for performing a link switch to that lower ranked target link has been fulfilled. This may mean that the device 16 only attempts to perform a link switch to a portion of the target links for which the respective condition has been fulfilled. Accordingly, the ranking of target links in this case may limit the number of access attempts so as to reduce control signaling overhead.

In other embodiments, by contrast, the device 16 may attempt to access a lower ranked target link after attempting to access a higher ranked target link, but before that attempt is deemed to have succeeded or failed. Where, for instance, an attempt to access a target link involves transmitting a random access preamble for random access to the target link, the device 16 may transmit a first random access preamble for random access to a higher ranked target link and then transmit a second random access preamble for random access to a lower ranked target link, without waiting for a random access response to the first random access preamble, i.e., without waiting to see if random access to the higher ranked target link succeeded. In this case, then, the device 16 may actually attempt to perform a link switch to all of the target links for which the respective condition has been fulfilled, e.g., in the sense that the device 16 engages in at least a portion of a procedure for link access. These embodiments may thereby provide faster access. e.g., faster handover, when the higher ranked target links end up being inaccessible, at the potential expense of increased control signaling overhead.

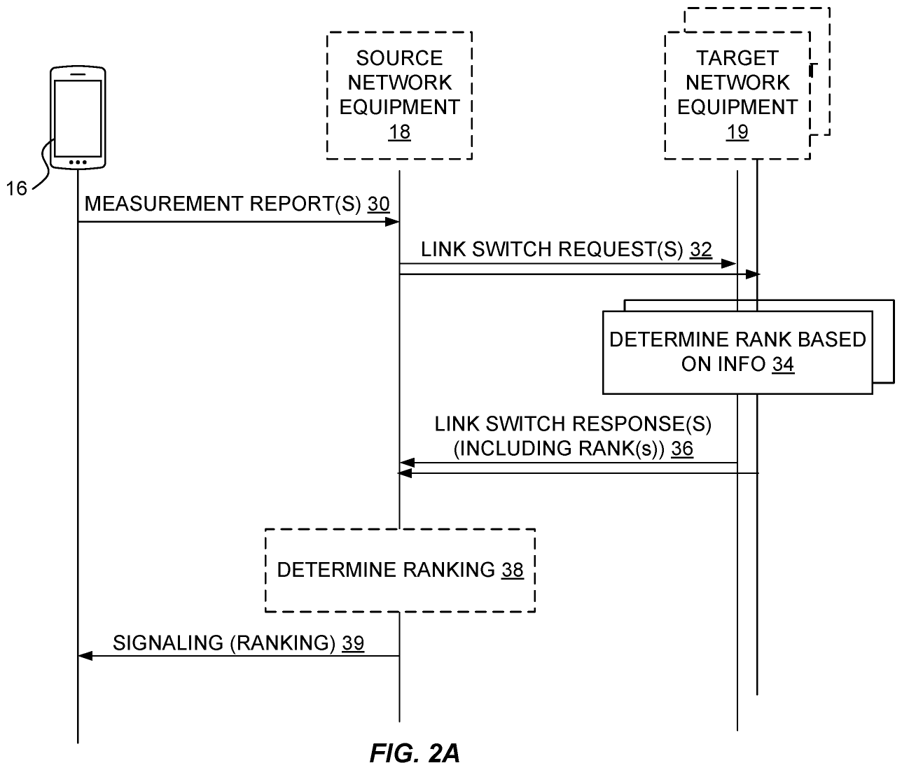

In any event, as suggested above, the ranking 26 of target cells may be determined by the network 10 and signaled explicitly or implicitly to the wireless device 16, or may be determined by the wireless device 16 itself, e.g., based on information signaled by the network 10 to the wireless device 16. FIGS. 2A-2C illustrate various embodiments in this regard.

FIG. 2A shows one example for embodiments in which the network 10 explicitly signals the ranking 26 to the wireless device 16, based on ranks self-determined by target network equipment(s) providing the target links of a potential link switch. As shown, the wireless device 16 may transmit one or more measurement reports 30 to source network equipment 18 providing a source link of the potential link switch. Responsive to the measurement report(s) 30, the source network equipment 18 may determine a set of target links to evaluate as candidates for commanding the wireless device 16 to conditionally perform a link switch. The source network equipment 18 in turn transmits one or more respective link switch requests 32 to one or more target network equipments 19 providing the target links in the set, e.g., in order to prepare each of the target links for the potential link switch.

Each target network equipment 19 may itself determine a rank for the target link that the target network equipment 19 provides, e.g., based on “ranking criteria” information available locally at the target network equipment 19 concerning the target link. Such ranking criteria information may include for instance information about resources prepared for the potential link switch, current or expected loading on the target link, with lower loading resulting in a higher rank, a type or coverage area size of the target link, statistics describing historical success or failure of link switches to the target link, with greater historical success resulting in a higher rank, a type of random access resources provided by the target link, with provision of content-free random access resources resulting in a higher rank, and/or a validity timer of resources provided by the target link, with longer resource validity resulting in a higher rank. Regardless of how each target network equipment 19 determines the rank of its respective target link, each target network equipment 19 may transmit a link switch response 36 to the source network equipment 18, e.g., in the form of a handover acknowledgement that may include an RRC configuration to use for the target link. Each link switch response 36 may include the rank of the target link as determined by the respective target network equipment 19. In some embodiments, for instance, the rank is embedded in, included in, or otherwise associated with the RRC configuration.

After receiving the link switch response(s) 36, the source network equipment 18 may transmit signaling indicating the ranking 26 of target links by relaying the ranks to the wireless device 16, e.g., as included in or associated with the RRC configurations. With determination of the ranks of the target links being distributed among target radio network equipment, e.g., in an uncoordinated fashion, the ranking 26 in this case may really just rank each target link relative to a common reference, based on the same underlying ranking criteria, rather than ranking each target link against one another. In other embodiments, therefore, the source network equipment 18 may itself determine the ranking 26 (Block 38) based on the individual ranks received from the target network equipment 19 in the link switch response(s) 36. The source network equipment 18 may for instance determine the ranking 26 based on the received ranks, in conjunction with ranking criteria information available at the source network equipment 18. This ranking criteria information may include some or all of the ranking criteria information described above for the target radio network equipment to determine rank and may be local to the source network equipment and/or received from the target network equipment(s) 19. In doing so, the source network equipment 18 may actually rank the target links against one another.

Regardless of how the ranking 26 is determined, the source network equipment 18 as shown transmits to the wireless device 16 signaling 39 indicating the ranking 26. The signaling 39 may be included in or be otherwise associated with conditional link switch command(s) that command the wireless device 16 to conditionally perform the link switch, where such command(s) may for instance take the form of RRC connection reconfiguration message(s).

In one embodiment, the signaling 39 explicitly indicates the ranking 26 of target links by indicating a list of target links and indicating a rank for each target link in the list. In another embodiment, the signaling implicitly indicates the ranking 26 of target links by indicating a list of target links, with the target links ordered in the list according to the ranking 26.

In either case, though, the ranking 26 may be exclusive to, or merely inclusive of, the target links that are indicated to the wireless device 16 as candidates for access or that the wireless device 16 is commanded to conditionally perform a link switch to. For example, in some embodiments, the ranking 26 constitutes a ranking of a set of potential target links which may include more than just the target links to which the wireless device 16 is commanded to conditionally perform a link switch to. In this case, though, other signaling may indicate which of the potential target links are target links to which the wireless device 16 is commanded to conditionally perform a link switch. In fact, in some embodiments, the source network equipment 18 determines for itself the ranking 26 of target links in the set that are being evaluated as candidates (Block 38) and decides, based on that ranking, to which of the target links in the set the source network equipment 18 is to command the wireless device 16 to conditionally perform a link switch. The source network equipment 18 may then transmit to the wireless device 16 signaling, in accordance with the decision, indicating target links to which the wireless device 16 is commanded to conditionally perform a link switch. With regard to any target links that the source network equipment 18 decides not to command the wireless device 16 to conditionally perform a link switch to, the source network equipment 18 may transmit release signaling to any target network equipment 19 providing such a target link to which the wireless device 16 is not commanded to conditionally perform a link switch. This release signaling may indicate to release any resources that were prepared for a link switch to the target link.

FIG. 2B illustrates other embodiments that do not rely on the target network equipments 19 self-determining the ranks for their own target links. Instead, in these embodiments, the target network equipments 19 transmit the underlying ranking criteria information to the source network equipment 18, e.g., within or in association with their link switch response(s) 40 as shown in FIG. 2B. The source network equipment 18 may then determine the ranking 26 based, at least in part, on the ranking criteria information received from each of the one or more target network equipment 19 (Block 42).

FIG. 2C illustrates still other embodiments in which the wireless device 16 itself determines the ranking 26 of the target links. In this case, the source network equipment 18 transmits the underlying ranking criteria information 46 to the wireless device 16, and the wireless device 16 itself determines the ranking 26 based on that information (Block 48). The source network equipment 18, as shown, may for instance receive at least some of the ranking criteria information 26 from the target network equipment 19, e.g., e.g., within or in association with their link switch response(s) 44 as shown in FIG. 2C.

FIG. 2D illustrate yet other embodiments in which the source network equipment 18 determines the ranking of target links, at least tentatively, before transmitting the link switch request(s) to the target network equipment 19. As shown, for instance, the source network equipment 18 determines the ranking 18, e.g., based on ranking criteria information described above, after receiving the measurement report(s) 30. The source network equipment 18 then transmits to each target network equipment providing a respective target link a link switch request 52 that includes the rank of that target link in the determined ranking. Each target network equipment 19 may then allocate resources, e.g., random access radio resources, on its respective target link based on the rank indicated in the received request (Block 54). This may involve allocating a certain number or type of resources, if any, for the potential link switch, depending on how high or low the target link's rank is, e.g., the lower the rank, the less likely the link switch to that particular target link, and therefore fewer resources or fewer scarce resources may be allocated for the potential link switch. For example, target network equipment 19 may determine whether to allocate contention-free random access radio resources on the target link, based on a rank of the target link, e.g., no contention-free random access radio resources may be allocated if the rank falls below a threshold rank. Alternatively or additionally, target network equipment 19 may determine how many contention-free random access radio resources on the target link to allocate, in dependence on a rank of the target link. Regardless, target network equipment 19 may thereafter transmit respective link switch responses 54 to the source network equipment 18 so that the process procedures as otherwise described above.

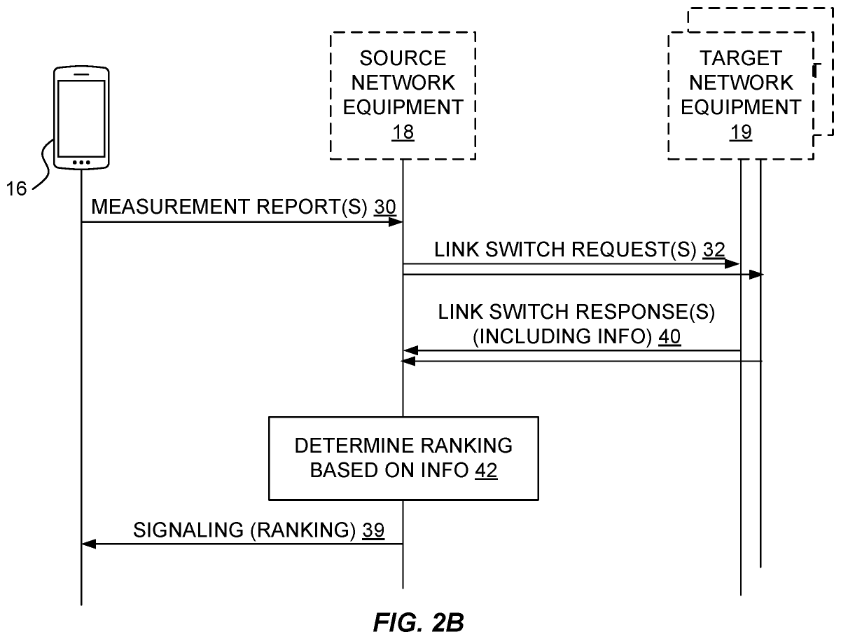

In view of the above, FIG. 3 depicts a method in accordance with particular embodiments. The method is performed by a wireless device 16 configured for use in a wireless communication network 10. The method as shown may include, in connected mode, e.g., RRC connected mode, attempting to access one or more target links 20 in order of a ranking of multiple target links that are candidates for the wireless device 16 to access (Block 310). In some embodiments for example where the target links are candidates for the wireless device to switch to accessing via a link switch, e.g., a conditional handover, to be performed in the connected mode, this may involve attempting to perform the link switch in the connected mode to one or more of the target links in order of the ranking.

In some embodiments, the method may alternatively or additionally include receiving from the wireless communication network 10 information based on which the wireless device 16 determines the ranking (Block 300). The information may for instance explicitly indicate the ranking (e.g., whereby the device's determination involves reading the explicit signaling from the network 10). Alternatively, the information may implicitly indicate the ranking or otherwise indicate information based on which the device 16 determines the ranking, e.g., according to one or more defined rules.

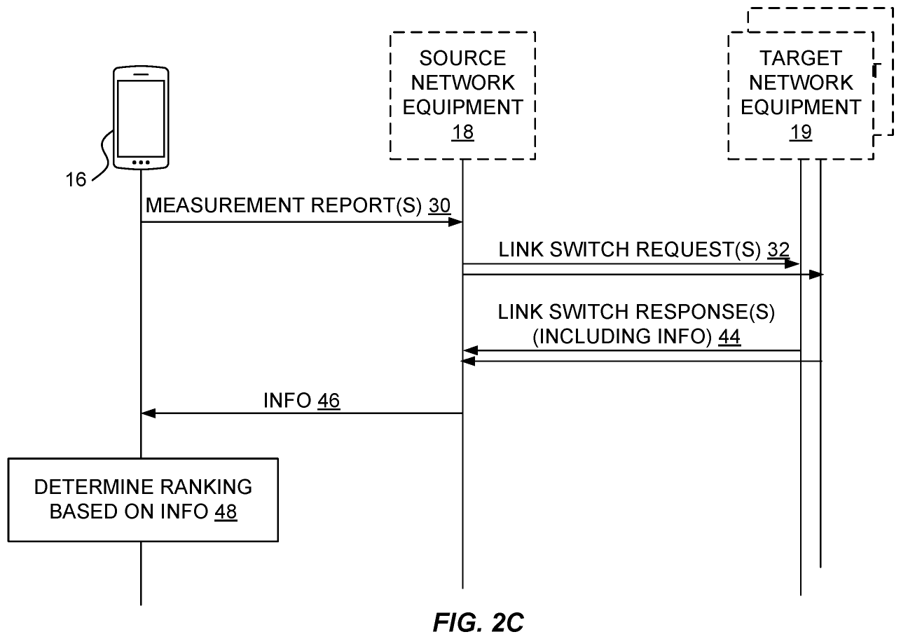

FIG. 4 depicts a method in accordance with other particular embodiments. The method is performed by network equipment 18 configured for use in a wireless communication network 10. The method may include transmitting to a wireless device 16 information explicitly or implicitly indicating a ranking of multiple target links 20 that are candidates for the wireless device 16 to access in connected mode (Block 410). The information may for instance explicitly indicate the ranking. Alternatively, the information may implicitly indicate the ranking or otherwise indicate information based on which the device 16 determines the ranking, e.g., according to one or more defined rules. In some embodiments, particularly where the information explicitly indicates the ranking, the method may further include determining the ranking of the target links (Block 400).

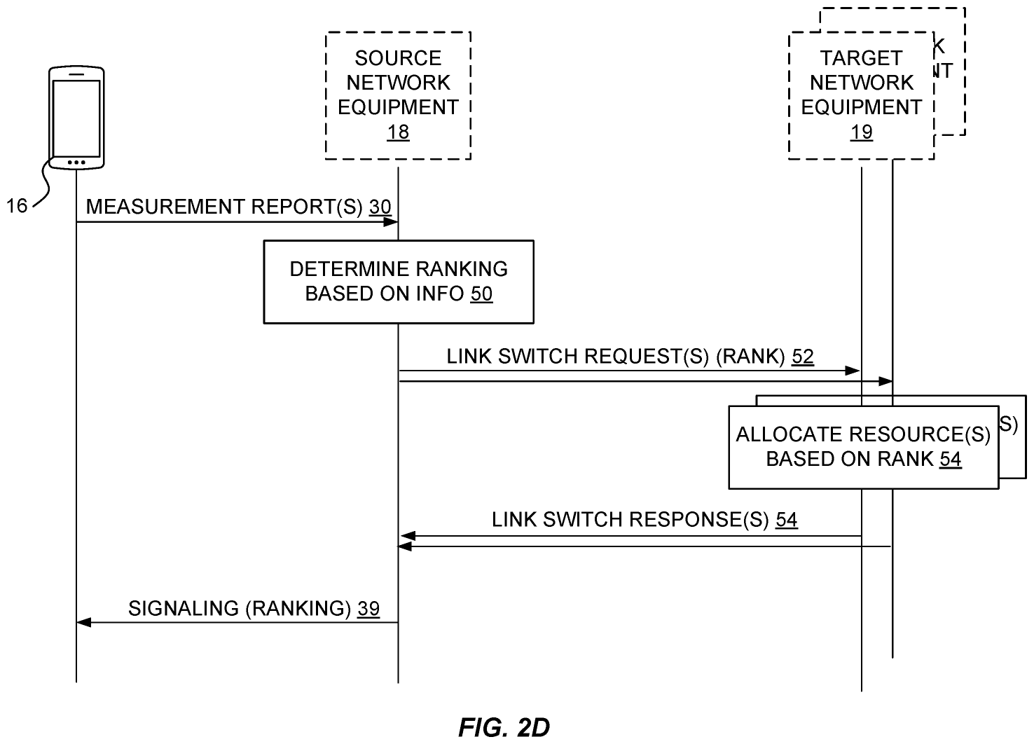

FIG. 5 depicts yet another method in accordance with other embodiments that concern a conditional link switch. The method is performed by a wireless device 16 configured for use in a wireless communication network 10. The method as shown may include receiving from the network equipment 18 signaling that indicates a ranking of target links to which the wireless device 16 is commanded to conditionally perform a link switch (Block 500). The signaling may for instance explicitly indicate the ranking. In some embodiments, the signaling indicating the ranking of the target links is included in one or more conditional link switch commands that command the wireless device to conditionally perform the link switch to the target links. Alternatively or additionally, the signaling indicating the ranking of the target links to which the wireless device is commanded to conditionally perform a link switch comprises signaling indicating a ranking of a set of potential target links and signaling indicating which of the potential target links are target links to which the wireless device is commanded to conditionally perform a link switch.

In some embodiments, the method may also include receiving multiple radio resource control, RRC, connection reconfiguration messages for respective target links. In this case, the RRC connection reconfiguration message received for a respective target link commands the wireless device to perform a link switch to the target link upon fulfillment of a respective condition. In other embodiments, the method may instead include receiving one RRC connection reconfiguration message for the target links. In this case, the one RRC connection reconfiguration message commands the wireless device to perform a link switch to any of the target links for which the same condition is fulfilled.

In some embodiments, the method may further include, responsive to detecting fulfillment of one or more conditions for performing a link switch to any of certain ones of the target links, attempting to perform a link switch to one or more of the certain target links in order of the indicated ranking, i.e., amongst the target links for which the condition for a link switch is fulfilled (Block 510). More particularly, in some embodiments, for each of the target links, the wireless device 16 is commanded to perform a link switch to the target link upon the fulfillment of a respective condition. The method may then include, for each of one or more of the target links, detecting fulfillment of the condition for performing a link switch to that target link. The method may also include attempting to perform a link switch to at least some of the one or more target links for which the condition has been fulfilled, in order of the indicated ranking.

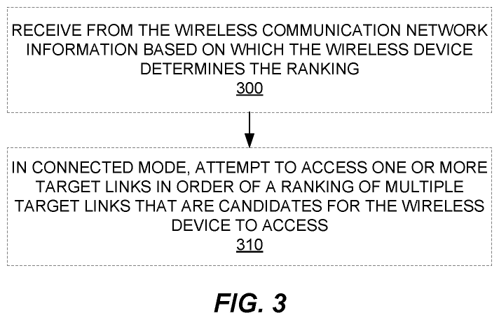

FIG. 6 depicts a method in accordance with other particular embodiments. The method is performed by network equipment 18 configured for use in a wireless communication network 10. The method may include transmitting to a wireless device 16 signaling that indicates a ranking of target links to which the wireless device 16 is commanded to conditionally perform a link switch (Block 610). The signaling may for instance explicitly indicate the ranking. In some embodiments, the signaling indicating the ranking of the target links is included in one or more conditional link switch commands that command the wireless device to conditionally perform the link switch to the target links. Alternatively or additionally, the signaling indicating the ranking of the target links to which the wireless device is commanded to conditionally perform a link switch comprises signaling indicating a ranking of a set of potential target links and signaling indicating which of the potential target links are target links to which the wireless device is commanded to conditionally perform a link switch.

In some embodiments, the method may also include transmitting multiple radio resource control, RRC, connection reconfiguration messages for respective target links. In this case, the RRC connection reconfiguration message transmitted for a respective target link commands the wireless device to perform a link switch to the target link upon fulfillment of a respective condition. In other embodiments, the method may instead include transmitting one RRC connection reconfiguration message for the target links. In this case, the one RRC connection reconfiguration message commands the wireless device to perform a link switch to any of the target links for which the same condition is fulfilled.

In some embodiments, the method may further include determining, e.g., calculating, the ranking of the target links (Block 600). For example, in some embodiments, determining the ranking of the target links is based, at least in part, on information received from each of one or more network equipment providing the target links. The information may for instance include information about resources prepared for a link switch to a target link provided by that network equipment. Generally, though, the ranking of the target links may be determined based on one or more of: information about resources prepared for the potential link switch, current or expected loading on the target link with lower loading resulting in a higher rank, a type or coverage area size of the target link, statistics describing historical success or failure of link switches to the target link with greater historical success resulting in a higher rank, a type of random access resources provided by the target link, and/or a validity timer of resources provided by the target link.

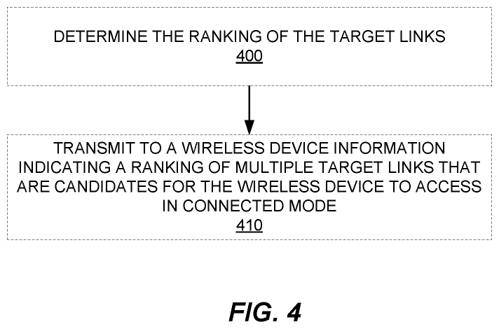

FIG. 7 depicts a method in accordance with other particular embodiments. The method is performed by source network equipment 18 configured for use in a wireless communication network 10. The method may include transmitting, to target network equipment 19 providing a target link, a link switch request 52 that includes a rank of that target link in a ranking of target links to which a wireless device 16 is to be commanded to conditionally perform a link switch (Block 710). In some embodiments, the method also includes determining the ranking 26 of the target links (Block 700).

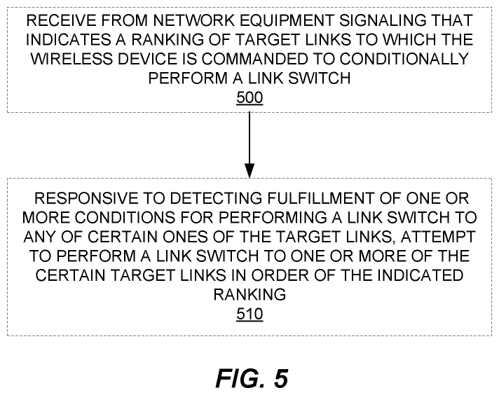

FIG. 8 depicts a method in accordance with still other particular embodiments. The method is performed by target network equipment 19 configured for providing a target link in a wireless communication network 10. The method may include receiving, from source network equipment 18, a link switch request 52 that includes a rank of that target link in a ranking of target links to which a wireless device 16 is to be commanded to conditionally perform a link switch (Block 800). In some embodiments, the method also includes allocating resources, e.g., random access radio resources, on the target link based on the rank of the target link (Block 810).

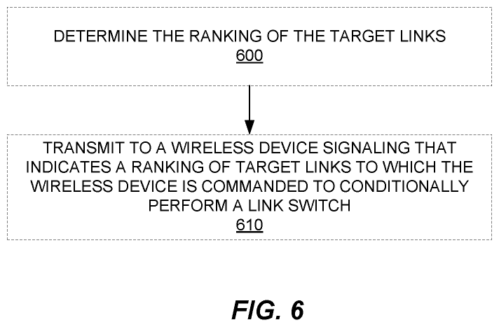

FIG. 9 depicts a method in accordance with still other particular embodiments. The method is performed by target network equipment 19 configured for providing a target link in a wireless communication network 10. The method may include receiving a link switch request 32 that requests the target network equipment 19 to prepare for a link switch to a target link provided by the target network equipment (Block 900). The method also includes, responsive to the link switch request 32, transmitting, to source network equipment 18 providing a source link, a rank of the target link for the link switch (Block 910). The rank may be included for instance in a link switch response 36. In some embodiments, the method may also include determining the rank of the target link (Block 920).

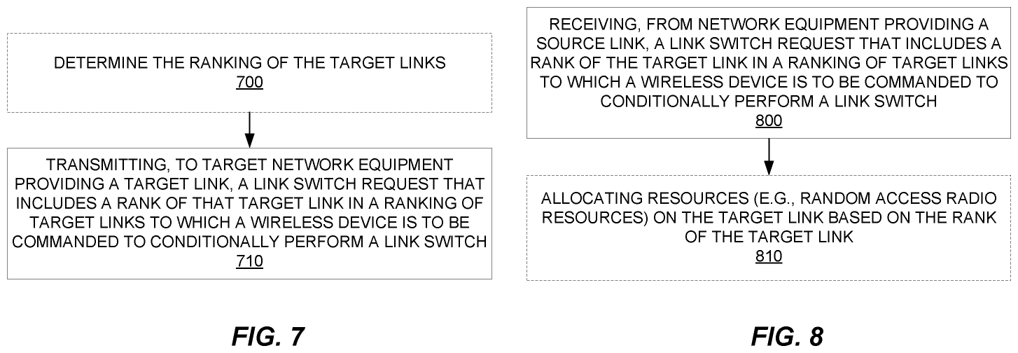

FIG. 10 depicts a method in accordance with other particular embodiments. The method is performed by source network equipment 18 configured for use in a wireless communication network 10. The method may include transmitting a link switch request 32 that requests target network equipment 19 to prepare for a link switch to a target link provided by the target network equipment 19 (Block 1000). The method may also include, responsive to the link switch request 32, receiving, from the target network equipment 19, a rank of the target link for the link switch (Block 1010).

Note that the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

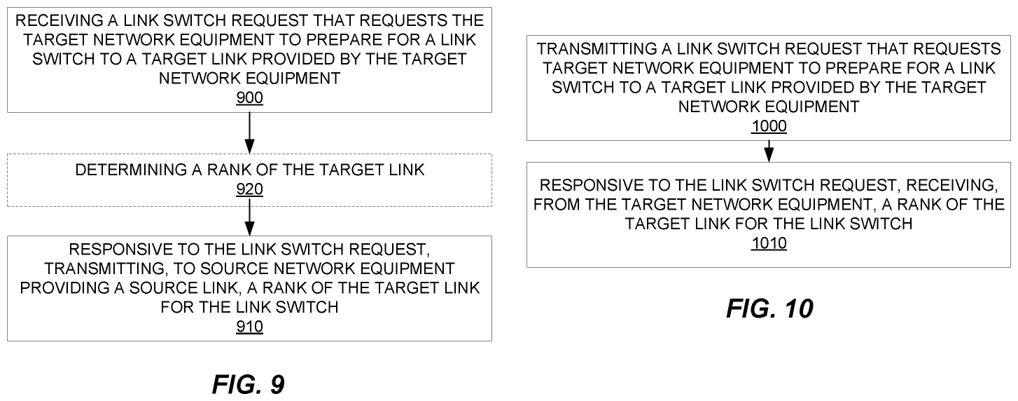

FIG. 11 for example illustrates a wireless device 1100, e.g., wireless device 16, as implemented in accordance with one or more embodiments. As shown, the wireless device 1100 includes processing circuitry 1110 and communication circuitry 1120. The communication circuitry 1120, e.g., radio circuitry, is configured to transmit and/or receive information to and/or from one or more other nodes, e.g., via any communication technology. Such communication may occur via one or more antennas that are either internal or external to the wireless device 1100. The processing circuitry 1110 is configured to perform processing described above, e.g., in FIGS. 3 and/or 5, such as by executing instructions stored in memory 1130. The processing circuitry 1110 in this regard may implement certain functional means, units, or modules.

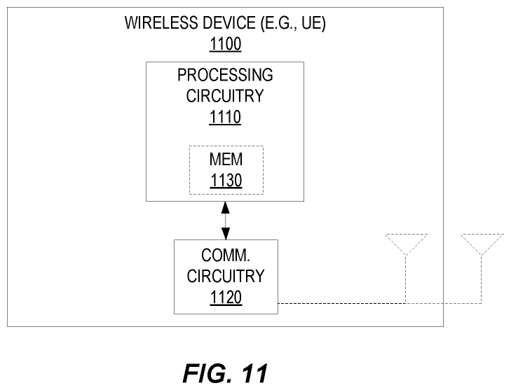

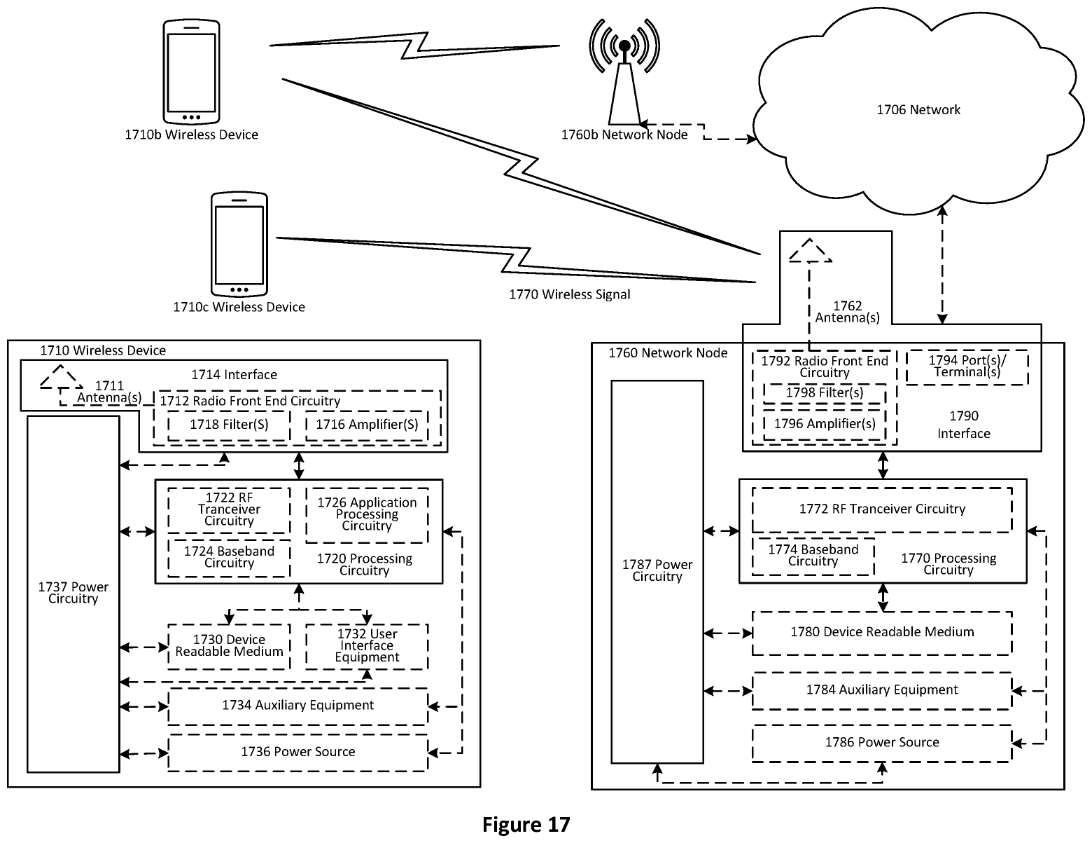

FIG. 12 illustrates a schematic block diagram of a wireless device 1200, e.g., wireless device 16, in a wireless network according to still other embodiments, for example, the wireless network shown in FIG. 17. As shown, the wireless device 1200 implements various functional means, units, or modules, e.g., via the processing circuitry 1110 in FIG. 11 and/or via software code. These functional means, units, or modules, e.g., for implementing the method(s) herein, may include for instance a receiving unit 1210 and/or an access attempting unit 1220. In some embodiments, the receiving unit 1210 may for instance be for receiving from network equipment signaling that indicates a ranking of target links to which the wireless device 1200 is commanded to conditionally perform a link switch. In some embodiments, the access attempting unit 1220 may be for, in connected mode, attempting to access one or more target links in order of a ranking of multiple target links that are candidates for the wireless device to access.

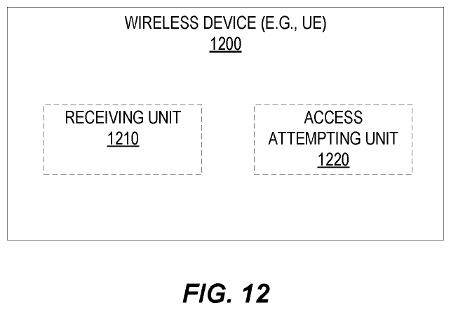

FIG. 13 illustrates a network equipment 1300, e.g., network equipment 18 or 19, as implemented in accordance with one or more embodiments. As shown, the network equipment 1300 includes processing circuitry 1310 and communication circuitry 1320. The communication circuitry 1320 is configured to transmit and/or receive information to and/or from one or more other equipment, e.g., via any communication technology. The processing circuitry 1310 is configured to perform processing described above, e.g., in any of FIGS. 4 and 6-10, such as by executing instructions stored in memory 1330. The processing circuitry 1310 in this regard may implement certain functional means, units, or modules.

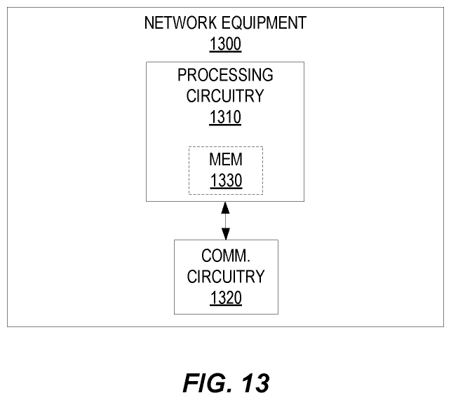

FIG. 14 illustrates a schematic block diagram of network equipment 1400, e.g., network equipment 18 or 19, in a wireless network according to still other embodiments; for example, the wireless network shown in FIG. 17. As shown, the network equipment 1400 implements various functional means, units, or modules, e.g., via the processing circuitry 1310 in FIG. 13 and/or via software code. These functional means, units, or modules, e.g., for implementing the method(s) herein, include for instance a transmitting unit 1410 and/or a ranking unit 1420.

In some embodiments, the transmitting unit 1410 may be for transmitting to a wireless device signaling that indicates a ranking of target links to which the wireless device is commanded to conditionally perform a link switch. Alternatively or additionally, the ranking unit 1420 may be for determining, e.g., calculating, the ranking of the target links.

In other embodiments, the transmitting unit 1410 may be for transmitting to target network equipment providing a target link a link switch request that includes a rank of that target link in a ranking of target links to which a wireless device is to be commanded to conditionally perform a link switch.

In still other embodiments, the transmitting unit 1410 may be for transmitting to a wireless device information explicitly or implicitly indicating a ranking of multiple target links that are candidates for the wireless device to access in connected mode. Alternatively or additionally, the ranking unit 1420 may be for determining, e.g., calculating, the ranking of the target links.

In yet other embodiments, the transmitting unit 1410 may be for transmitting, to target network equipment providing a target link, information indicating a rank of that target link in a ranking of target links that are candidates for a wireless device to access in connected mode.

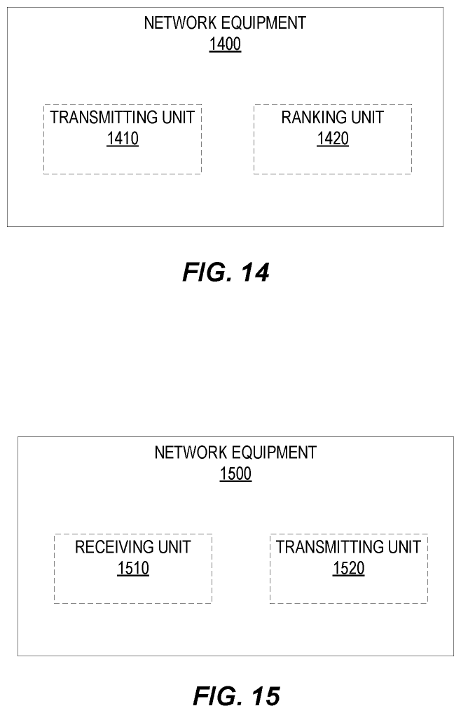

FIG. 15 illustrates a schematic block diagram of network equipment 1500, e.g., network equipment 18 or 19, in a wireless network according to yet other embodiments; for example, the wireless network shown in FIG. 17. As shown, the network equipment 1500 implements various functional means, units, or modules, e.g., via the processing circuitry 1310 in FIG. 13 and/or via software code. These functional means, units, or modules, e.g., for implementing the method(s) herein, include for instance a receiving unit 1510 and/or a transmitting unit 1520.

In some embodiments, the receiving unit 1510 is for receiving, from network equipment providing a source link, a link switch request that includes a rank of the target link in a ranking of target links to which a wireless device is to be commanded to conditionally perform a link switch.

In other embodiments, the receiving unit 1510 is for receiving a link switch request that requests the target network equipment to prepare for a link switch to a target link provided by the target network equipment. In these and other embodiments, the transmitting unit 1520 may be for, responsive to the link switch request, transmitting, to source network equipment providing a source link, a rank of the target link for the link switch.

In still other embodiments, the transmitting unit 1520 may be for transmitting a link switch request that requests target network equipment to prepare for a link switch to a target link provided by the target network equipment. In these and other embodiments, the receiving unit 1510 may be for, responsive to the link switch request, receiving, from the target network equipment, a rank of the target link for the link switch.

In yet other embodiments, the receiving unit 1510 may be for receiving, from network equipment providing a source link, information indicating a rank of that target link in a ranking of target links that are candidates for a wireless device to access in connected mode.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable storage or recording medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts and/or wireless network types for illustrative purposes, but the embodiments are similarly applicable in other contexts and/or wireless network types not explicitly described.

In order to avoid the undesired dependence on the serving radio link upon the time (and radio conditions) where the user equipment (UE) should execute the handover (HO), New Radio (NR) should offer the possibility to provide radio resource control (RRC) signaling for the handover to the UE earlier. To achieve this, it should be possible to associate the HO command with a condition. As soon as the condition is fulfilled, the UE may execute the handover in accordance with the provided handover command. Such a condition could e.g. be that the quality of the mobility reference signal (MRS) of the target cell or beam becomes X dB stronger than the MRS of the serving cell, where MRS here is exclusively used to denote the reference signal used for mobility purpose, e.g., in NR, MRS can be either synchronization signal block (SSB) or channel state information reference signal (CSI-RS). The threshold Y used in a preceding measurement reporting event should then be chosen lower than the threshold X in the handover execution condition. This allows the serving cell to prepare the handover upon reception of an early measurement report and to provide the RRCConnectionReconfiguration with mobilityControlInfo, i.e., the HO command, at a time when the radio link between the source cell and the UE is still stable. The execution of the handover is done at a later point in time (and threshold) which is considered optimal for the handover execution.

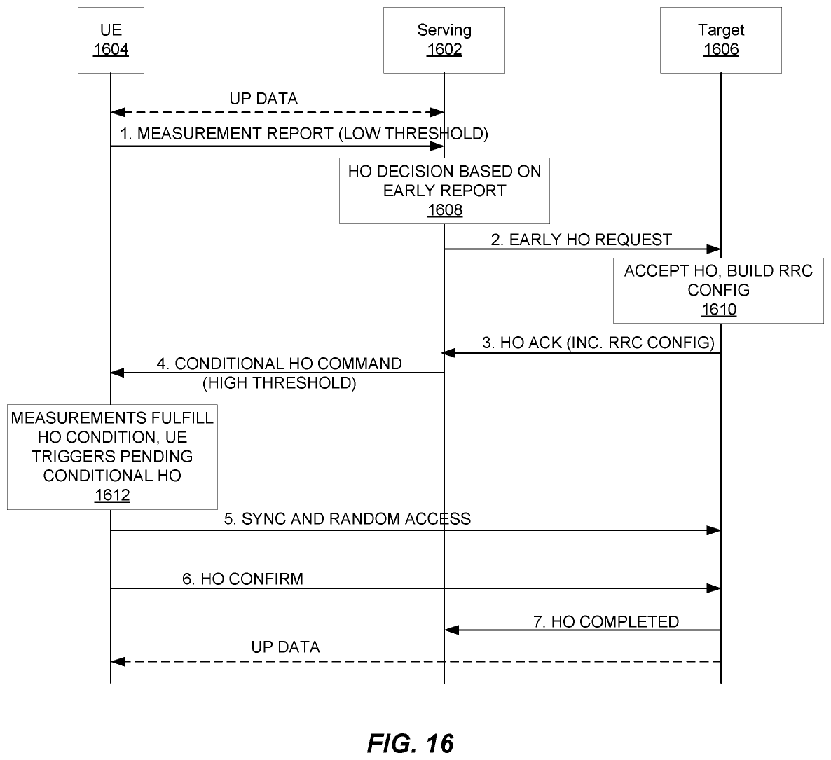

FIG. 16 depicts an example with just a serving and a target cell. As shown, in step 1, e.g., after having received user plane, UP, data from the serving cell 1602, the UE 1604 transmits a measurement report to the serving cell 1602 indicating a measurement of a target cell 1606. The UE 1604 may do so for instance responsive to the signal measurement, e.g., SINR, exceeding a “low” threshold that is lower than a “high” threshold, where the “low” threshold may for instance be that the signal measurement becomes Y dB stronger than the corresponding signal measurement of the serving cell 1602. In response, the serving cell 1602 makes a HO decision based on the UE's measurement report, which arrives earlier than it would have had the “high” threshold been used as the trigger for the measurement report (Block 1608). The serving cell 1602 based on this HO decision sends a HO request to the target cell 1606 (Step 2), which again occurs earlier than would have otherwise occurred with the “high” threshold. The target cell 1606 in this example accepts the HO and builds the RRC reconfiguration message to send to the UE 1604 for indicating the RRC configuration to use with respect to the target cell 1606 (Block 1610). The target cell 1606 then sends a HO acknowledgement message to the serving cell 1602 along with the RRC reconfiguration message (Step 3).

The serving cell 1602 then transmits a conditional HO command to the UE 1604, e.g., in the form of the RRC reconfiguration message received from the target cell 1606 (Step 4). The conditional HO command in this regard may include or otherwise be associated with a condition for performing a HO to the target cell 1606. As shown, for example, the condition takes the form of the “high” threshold that the signal measurement of the target cell 1606 must meet in order for the UE 1604 to perform HO to the target cell 1606. Indeed, as shown in this example, after the signal measurement of the target cell 1606 fulfills the HO condition (namely, the “high” threshold) (Block 1612), the UE 1604 attempts access to the target cell 1606. In particular, the UE 1604 performs synchronization with and random access to the target cell 1606 (Step 5). The UE 1604 then transmits a HO confirmation to the target cell 1606 (Step 6), after which the target cell 1606 transmits a HO completed message to the serving cell 1602 (Step 7). The UE 1604 may then be served by UP data to or from the target cell 1606.

In practice there may often be many cells or beams that the UE reported as possible candidates based on its preceding radio resource management (RRM) measurements. The network should then have the freedom to issue conditional handover commands for several of those candidates. The RRCConnectionReconfiguration for each of those candidates may differ, e.g., in terms of the HO execution condition, e.g., reference signal, RS, to measure and threshold to exceed, as well as in terms of the random access (RA) preamble to be sent when a condition is met.

The RRCConnectionReconfiguration is typically a “delta” to the UE's current configuration. In LTE, the UE shall apply RRCConnectionReconfiguration messages in the order in which it receives them. On the other hand, the Universal Mobile Telecommunications System (UMTS) allowed associating a reconfiguration message with an “Activation Time”. This led to race conditions and numerous problems when the UE received a first reconfiguration with a longer Activation Time than the Activation Time of a subsequent reconfiguration message. The LTE mechanism is simpler and more robust and may be adopted also for NR. And it may be ensured that the “conditional handover” mechanism discussed above does not suffer from similar problems as the activation time problems observed in UMTS.

As explained above, the triggering condition associated with the HO command sent to the UE should evaluate measurements and trigger the handover when those conditions are fulfilled. But since the HO command is typically a delta to the UE's current RRC configuration, one may address how to handle subsequent RRCConnectionReconfiguration messages arriving from the source cell if the UE has not yet executed the handover.

When the UE receives a “conditional HO command” it should interpret the RRCConnectionReconfiguration with mobilityControlInfo as a delta to its current configuration, unless it is a full configuration message. It may in principle determine the target configuration immediately upon reception of the command but it shall apply/execute it only if the associated condition is fulfilled. While the UE evaluates the condition it should continue operating per its current RRC configuration, i.e., without applying the conditional HO command.

When the UE determines that the condition is fulfilled, it disconnects from the serving cell, applies the conditional HO command and connects to the target cell. These steps are equivalent to the current, instantaneous handover execution. Once the UE applies the RRCConnectionReconfiguration including mobilityControlInfo, it shall not process any subsequent RRCConnectionReconfiguration messages received prior to the HO execution.

It may happen, though, that the HO condition is not fulfilled for a time period long enough for circumstances, e.g., channel conditions, at the UE to change appreciably. In this case, where the UE continues to stay in the source cell, the source cell might perform further reconfigurations either to change the UE operation in the current serving cell or to issue a handover to another target cell. In this scenario, the previously received conditional HO command cannot be applied as a delta to the new RRCConnectionReconfiguration as the original conditional HO command was built having current RRC configuration in mind.

To avoid additional signaling between network entities and towards the UE, in an optimized approach, the UE does not discard the conditional HO command when receiving the subsequent RRCConnectionReconfiguration for the serving cell. Instead, various enhancements may be considered.

A first enhancement involves updating the conditional handover command. In particular, the network may decide to provide a new, updated RRCConnectionReconfiguration in a conditional HO command for a target cell for which it had previously provided a conditional HO command. Correspondingly, if the UE receives a conditional HO command for a target cell for which it has already a pending conditional HO command, it determines the target cell configuration based on its current serving cell configuration and the “delta” in the HO command and uses it towards the target cell.

A second enhancement involves extending the validity of the conditional handover command. In this regard, the source may ask the target to prolong the conditional HO command validity and, if granted by target, send a new time limit to the UE for the conditional HO command that allows more time before the conditional HO command is triggered.

A third enhancement concerns changing target cells. In this enhancement, the source cell can decide based on the RRM measurements that the potential target cell must be changed. In this scenario, the source cell provides the conditional HO command to the UE with a new target cell and indicates that the UE shall discard the earlier provided conditional HO command. Correspondingly, the UE shall be prepared to receive simultaneously the cancellation of a previously received pending HO command to a first target cell and a new/updated conditional HO command for a second target cell.

A fourth enhancement concerning preparing multiple target links for conditional handover. In particular, it may be desirable to provide the UE with HO conditions and configurations for several candidate target links. When receiving conditional HO commands for multiple target links, the UE evaluates HO conditions for more than one candidate target link and stores configurations for those individually. This can be performed using two alternatives. In one alternative, the network informs in the conditional HO command that the RRCConnectionReconfiguration in the conditional HO command is applicable for several cells. That is, the same conditional HO command applies to multiple cells. When the UE receives this kind of conditional HO command, it stores only one configuration associated with multiple target cells. Alternatively, the network provides a conditional HO command with multiple cells and potentially multiple configurations. When receiving such configuration, the UE stores the current serving cell RRC configuration (RRC context). When the HO is triggered, the UE derives the corresponding target cell configuration based on said source cell configuration stored upon reception of the HO command and the parameters provided in the conditional HO command.

There currently exist certain challenge(s). It may be possible to send one conditional handover command with condition(s) intended for multiple cells. In this case, it may be unclear which target cell the UE will try to access in case of handover. If such decision is left for UE implementation, it provides the network with less control over the UE, which may not be desirable.

Certain aspects of the present disclosure and their embodiments may provide solutions to these or other challenges.

In some embodiments herein, the network may provide the UE with a priority ranking when the UE is configured with multiple target cells such as for handovers, conditional handover, setup of dual connectivity, setup of multi-RAT dual connectivity, setup of carrier aggregation, etc.

In one set of embodiments, a command may be a conditional handover command where the UE is configured to access one or multiple of the configured cells in the indicated priority ranking when the pre-defined conditions are fulfilled. It doesn't restrict the scenario if single or multiple condition is configured in the UE for handover purposes. Several schemes are proposed to calculate such priority rank.

Some embodiments for example include a method in a network node comprising calculation of priority ranking for the target cells and sending this priority to the UE. Other embodiments include a method in a terminal, e.g., UE, comprising receiving a priority ranking from the network node and performing handover based on the priority ranking.

Certain embodiments may provide one or more of the following technical advantage(s). Some embodiments enable the network to prepare handover decisions more effectively and efficiently. It is expected that a network deploying such a scheme would provide more robustness to the handover performance.

Consider now the priority ranking in more detail. In the embodiments below, the network may provide the UE with priority information in a handover command, in a conditional handover command, or with any command that triggers the UE to access a given neighbor cell. Other cases could be the setup of carrier aggregation, dual connectivity, multi-RAT dual connectivity like EN-DC, etc.

This description simply uses the term handovers to indicate ordinary handover, conditional handovers or any of these accesses of neighbor cells.

In terms of messages, the command used herein can be an RRCConnectionReconfiguration indicating that this is a handover, such as the mobilityControlInfo defined in LTE or, in NR, an RRCReconfiguration with a synchronousReconfiguration in the PCellConfig.

Consider now the priority information for indicating the priority ranking. In a set of embodiments, the priority information can be implicit. In one embodiment, implicit information can be the order of cells in the list provided in the RRC message, i.e., the RRC message that commands a conditional handover to one or more cells. That may indicate a ranking of cells where the highest priority is the one listed first. In one example, the UE only treats the first cell in the list as the highest priority while the other cells in the list all have same priority, lower than the first cell. In another example, each cell order in the list indicates their specific priority, i.e., first cell in the list has highest priority, second cell in the list has second highest priority and n-th cell in the list has the n-th highest priority.

In another set of embodiments, implicit information can be extracted from the random access channel (RACH) configuration associated to the configured cells. In one embodiment, the UE considers highest priority cell(s) the ones configured with contention-free RACH resources, while lower priority cells the ones without contention-free RACH resources.

In this regard, in NR multi-beam scenarios, each cell may transmit multiple beamformed reference signals (RS)s that can be detected by a UE. Each RS transmitted in each beam may carry some form of beam identifier. Before accessing a cell, e.g., a target cell during handover or dual connectivity setup, the UE needs to perform beam selection by performing measurements on these beamformed RS and selecting a DL beam. Based on that selection, the UE has in the RACH configuration a mapping between the DL beams associated to a given cell and the RACH resources to be used. Hence, after beam selection, the UE knows what exact RACH resources it should use to access the cell. The RS type that is beamformed can be SS/PBCH block (SSB) where each so called SSB can be transmitted in a different downlink beam. The RS type that is beamformed can be CSI-RS, where each configured resource associated to a given that is transmitted in a different downlink beam.

Generally in NR, the RRC configuration providing information to access a cell may contain: (a) only contention-based RACH resources mapped to SSB(s); (b) both contention-based RACH resources mapped to SSBs and contention-free RACH resources mapped to SSB(s); or (c) both contention-based RACH resources mapped to SSBs and contention-free RACH resources mapped to CSI-RS resources. In another embodiment, therefore, the UE considers highest priority cell(s) the ones with one of these RACH configurations, e.g., (c), while the remaining configurations have equally lower priority. For example, the priority rule can be: cells with (c) have highest priority and cells with (b) or (a) have equally lower priority. In another example, cells with (b) or (c) have highest priority and cells with (a) have lower priority. In yet another example, cells with (a) have highest priority and cells with (b) or (c) have lower priority. Any other combination is possible as well.

In yet another embodiment, the UE considers highest priority cell(s) the ones with one of these RACH configurations, e.g., (c), while another configuration has second highest priority and the other configuration the lowest priority. The priority order can be any of the following: configurations have equally lower priority. For example, the priority rule can be cells with (c) have highest priority, cells with (b) have the second highest priority, and cells with (a) have the lowest priority. Or, cells with (c) have highest priority, cells with (a) have the second highest priority, and cells with (b) have the lowest priority. Or, cells with (b) have highest priority, cells with (a) have the second highest priority, and cells with (c) have the lowest priority. Or, cells with (b) have highest priority, cells with (c) have the second highest priority, and cells with (a) have the lowest priority. Or, cells with (a) have highest priority, cells with (b) have the second highest priority, and cells with (c) have the lowest priority. Or, cells with (a) have highest priority, cells with (c) have the second highest priority, and cells with (b) have the lowest priority.

In yet another embodiment, in a broader sense, the UE considers highest priority cell(s) the ones with the RACH configurations associated to CSI-RS resources (e.g. for faster narrow beam selection) while the second highest priority are the ones with RACH configurations associated with SSBs.

In yet another embodiment, in a broader sense, the UE considers highest priority cell(s) the ones with the RACH configurations associated to SSBs, e.g. for more robust access, when SSB is transmitted in wider beams, while the second highest priority are the ones with RACH configurations associated with CSI-RS resources.

In yet another set of embodiments, the priority information can be explicit. For example, in another embodiment, explicit information can be provided for each cell in the list provided in the RRC message. Further details are provided later about the ranking.

Consider now a procedure failure timer. The procedure timer failure exists in LTE and in NR and is started at the UE when the procedure is started, e.g., upon receiving the message that starts the procedure. For example, upon receiving the RRCReconfiguration containing synchronousReconfiguration, the UE starts the timer and, when the timer expires without completing the procedure, the procedure is considered failed. If the procedure is completed before the timer expires, the procedure is considered successful and the timer is stopped. One example in LTE is the Handover failure timer, T307.

Consider now conditions fulfilled for accessing a cell which is not the highest priority. The conditions can be any of the ones described below or a combinations of these: (i) The cell quality, based on one or multiple quantities (e.g. RSRP, RSRQ and/or SINR), is above a configurable threshold; (ii) The cell quality, based on one or multiple quantities (e.g. RSRP, RSRQ and/or SINR), is above a fixed threshold defined in telecommunication specifications (e.g., 3GPP specifications); (iii) The beam quality associated to the cell the UE is trying to access, based on one or multiple quantities (e.g. reference signal received power (RSRP), reference signal received quality (RSRQ) and/or SINR), is above a configurable threshold; and/or (iv) The beam quality associated to the cell the UE is trying to access, based on one or multiple quantities (e.g. RSRP, RSRQ and/or SINR), is above a threshold fixed in the telecommunication specifications (e.g., 3GPP specifications).

The suitability criteria can be based on previously performed measurements or, every time a selection of new cells needs to be performed, the UE updates the measurements.

Priority ranking may refer to a priority order of the potential target cells where a UE performs handover execution. In one embodiment, the UE is only allowed to access one of the configured cells per time, when the priority per cell is configured in the handover message, with or without the additional configuration that this is of conditional handover, as described above. Upon receiving the configuration command, containing the “priority information” as described above, the UE accesses the highest priority and, if the access fails and the procedure is still running, e.g. a “procedure failure timer”, triggered when the procedure started and, when it expires the procedure is declared as failed, the UE accesses the second priority cell if the second priority cell fulfills suitability criteria. If that fails, the procedure continues until the timer is running and until there are configured cells to be attempted.

Consider one example for the handover case. Upon receiving a handover command with one or more neighbor cells and priorities associated to these cells, the UE shall set k=1 at the beginning. Then, in step 1, the UE performs the handover execution to the cell with the (k)th highest priority, where k starts with k=1. In step 2, if the access to the highest priority succeeds, the procedure is complete. Else, (Step 3) if the access to the (k)th highest priority fails, then the following is performed. If (Step 4) the “command failure timer”, as described further below is still running (possibly started when the UE receives the command to access the target cell) and if the suitability condition is fulfilled, then the UE increments k and goes back to STEP 1) i.e. access the configured cell with the (k+1)th highest priority. Otherwise, if the command failure timer is still running and the suitability condition is not fulfilled, the UE increments k and goes back to STEP 4) i.e. check if the timer is still running and if so, tries to access the configured cell with the (k+1)th highest priority. But if the “command failure timer” expires, the UE declares a procedure failure (e.g. handover failure or conditional handover failure or SCG addition failure) and stores failure information in radio link failure (RLF) or handover failure (HOF) related variables such as cell or cells that have failed, their radio conditions, etc.

Consider another example for the conditional handover case. Upon receiving a conditional handover command with one or more neighbor cells and priorities associated to these cells, and upon fulfilling the criteria that triggers the access to one of these cells, e.g. serving cell radio conditions is below a threshold, the UE shall set k=1 at the beginning. Then, in Step 1, the UE shall perform the handover execution to the cell with the (k)th highest priority k starts with k=1. In step 2, if the access to the highest priority succeeds, the procedure is complete. Else, (step 3), if the access to the (k)th highest priority fails, the UE performs the following. If (step 4) the “command failure timer”, as described further below is still running (possibly started when the UE receives the command to access the target cell) and if the suitability condition is fulfilled, the UE increments k and goes back to STEP 1) i.e. access the configured cell with the (k+1)th highest priority. Else, if the “command failure timer”, as described further below is still running (possibly started when the UE receives the command to access the target cell) and if the suitability condition is not fulfilled, the UE shall increment k and go back to STEP 4) i.e. check if the timer is still running and if so, try to access the configured cell with the (k+1)th highest priority. But if the “command failure timer” expires, the UE declares a procedure failure, e.g. handover failure or conditional handover failure or SCG addition failure, and store failure information in RLF/HOF related variables such as cell or cells that have failed, their radio conditions, etc.

In one embodiment, the UE is allowed to access multiple of the configured cells in order of priority, where an attempt to access a cell with subsequent priority can occur without the failure of the precedent priority cell. In other words, different from the previous embodiments, the UE does not need to detect an access failure before it accesses the second cell.

In another set of embodiments, the whole cell access prioritization, after the first one with highest priority, may be based on radio conditions. In a first embodiment, if the first fails the access of the highest priority cell, the UE considers as the second highest priority cell the cell with the highest measurement result value (for a single or multiple measurement quantity(ies), which can be fixed in the standard, e.g., RSRP, or configurable by the network e.g. in the RRCReconfiguration). In a second embodiment, the UE considers as the k-th highest priority cell the cell with the k-th highest measurement result value (for a single or multiple measurement quantity(ies), which can be fixed in the standard, e.g., RSRP, or configurable by the network e.g. in the RRCReconfiguration). In the case the UE accesses multiple cells even before declaring the failure, the order of access can be defined by the priorities defined by these radio measurements as described.

In some embodiments, in the case this is a conditional handover command, that is done upon satisfying a condition included in the command. In other words, the UE is provided with such ranking that specifies order of accessing target cells. During handover, if the UE can't access the top priority cell, it can continue towards the others. In one embodiment, the priority ranking can be sent at once for all candidate target cells. In some other embodiment, it is sent sequentially starting from highest priority target to the lowest or vice versa. The priority can be changed as a delta configuration at any time instant. In another embodiment, the source cell can send a pre-calculated priority rank of its neighbor cells to the UE and provide conditional handover for some of them. The UE thus implicitly can calculate the priority of the potential target. This pre-calculated priority rank can be updated if necessary.

Consider now calculation of priority rank. Calculation of priority rank can be performed in the network in different ways. In one embodiment, the target cell can send a self-priority indication along with the allocated resources and the source cell can arrange the target cell accordingly. The target cell can calculate self-priority based on statistics, e.g. (1) Cell type, e.g. Micro and Pico cells can have less priorities; (2) Current load and expected Load; (3) RLF, HOF statistics for the currently served UEs. Even if the target cell doesn't assign self-priority, it can send this information to the source cell along with the resource information.

In another embodiment, the source cell can calculate priority for multiple target cells based on the resource information and possibly the information from the previous embodiment. In addition to these information, the source cell can utilize some more statistics, e.g. (1) Previous handover statistics to the target cell(s) (Handover success/handover failure); (2) Beam information, e.g. how many beams the UE reported for the target cell(s) (this is useful in distributed transmission point (TP) scenario); (3) Validity timer of the resources indicated by the target cell(s); (4) The type of random access resources (contention-based random access (CBRA) or contention-free random access (CFRA)) provided by the target cell(s).

The source cell can also use some sort of heuristic methods to create the priority ranks; use of machine learning techniques such as classification learning or Reinforcement Learning can be used.

Furthermore, if the source cell receives handover resource information from multiple target cells, after prioritization, based on previous statistics, it can exclude one/more of them in the RRCConnectionReconfiguration with mobilityControlInfo command to the UE and explicitly inform those cells to release the prepared resources. This introduces additional X2 signaling but the resources in the target cells can be utilized immediately.

In another embodiment, the network takes the decision of priorities for the target cell before sending the handover request to the candidate target cells. In this embodiment, the network includes the priority as calculated in the HO request message. The target cell could use this information to decide on the number for CFRA (contention free random access) resources to be allocated to the UE. In one sub-embodiment, the target cell allocates CFRA only if it is amongst the ‘higher priority’ (defined by a threshold) target cell. In another sub-embodiment, the target cell scales the CFRA resources to be allocated to this UE based on the priority for this target cell (higher priority→more CFRA resources).

Handover resource information as used above may be for instance provided in a handover request acknowledge message. For example, the HANDOVER REQUEST ACKNOWLEDGE message includes a transparent container to be sent to the UE as an RRC message to perform the handover. The container includes a new cell radio network temporary identity (C-RNTI) and target eNB security algorithm identifiers for the selected security algorithms. The container may also include a dedicated random access channel (RACH) preamble and possibly some other parameters i.e. access parameters, system information blocks (SIBs), etc. If RACH-less HO is configured, the container includes timing adjustment indication and optionally a preallocated uplink grant. The HANDOVER REQUEST ACKNOWLEDGE message may also include radio network layer (RNL)/transport network layer (TNL) information for the forwarding tunnels, if necessary.

Consider now usage of the priorities for connection re-establishment upon handover failure, secondary cell group (SCG) setup failure, and SCG failure or radio link failure (RLF). In yet another set of embodiments, the abovementioned embodiments could be used as a fallback mechanism that would enable the UE to avoid going through a connection re-establishment procedure which consumes much more signaling over the air interface. By doing that, the UE is provided with fallback cells, i.e. in the previous embodiments, these would be the cells with lower priority, to be used in case the access to the access to the highest priority cell fails. That would enable the UE to avoid going through connection re-establishment if the failure of the first access and subsequent accesses occurs while the failure timer is running.

In yet another set of embodiments, a cell access prioritization procedure is used as a fallback mechanism that would enable the UE to maximize its chance to succeed in a connection re-establishment procedure. Assuming that only a subset of cells can be prepared for a successful re-establishment, e.g., the ones from the same node of the serving cell, there is a subset of detectable neighbor cells where the chance of succeeding is higher. In this case, the network can provide the UE with a list of cells and priorities associated to that chance. For example, the priority list can be simply the list of cells from the same node, e.g. gNodeB, and, upon re-establishment procedure, when the UE is performing cell reselection/selection, the UE prioritizes the ones indicated in that list, i.e., they would have highest priority. Suitability criteria as described above can be part of the procedure too.

Although the subject matter described herein may be implemented in any appropriate type of system using any suitable components, the embodiments disclosed herein are described in relation to a wireless network, such as the example wireless network illustrated in FIG. 17. For simplicity, the wireless network of FIG. 17 only depicts network 1706, network nodes 1760 and 1760b, and WDs 1710, 1710b, and 1710c. In practice, a wireless network may further include any additional elements suitable to support communication between wireless devices or between a wireless device and another communication device, such as a landline telephone, a service provider, or any other network node or end device. Of the illustrated components, network node 1760 and wireless device (WD) 1710 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), Narrowband Internet of Things (NB-IoT), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WMax), Bluetooth, Z-Wave and/or ZigBee standards.

Network 1706 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1760 and WD 1710 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 17, network node 1760 includes processing circuitry 1770, device readable medium 1780, interface 1790, auxiliary equipment 1784, power source 1786, power circuitry 1787, and antenna 1762. Although network node 1760 illustrated in the example wireless network of FIG. 17 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1760 are depicted as single boxes located within a larger box, or nested within multiple boxes, in practice, a network node may comprise multiple different physical components that make up a single illustrated component (e.g., device readable medium 1780 may comprise multiple separate hard drives as well as multiple RAM modules).

Similarly, network node 1760 may be composed of multiple physically separate components (e.g., a NodeB component and a RNC component, or a BTS component and a BSC component, etc.), which may each have their own respective components. In certain scenarios in which network node 1760 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1760 may be configured to support multiple radio access technologies (RATs). In such embodiments, some components may be duplicated (e.g., separate device readable medium 1780 for the different RATs) and some components may be reused (e.g., the same antenna 1762 may be shared by the RATs). Network node 1760 may also include multiple sets of the various illustrated components for different wireless technologies integrated into network node 1760, such as, for example, GSM, WCDMA, LTE, NR, WiFi, or Bluetooth wireless technologies. These wireless technologies may be integrated into the same or different chip or set of chips and other components within network node 1760.

Processing circuitry 1770 is configured to perform any determining, calculating, or similar operations (e.g., certain obtaining operations) described herein as being provided by a network node. These operations performed by processing circuitry 1770 may include processing information obtained by processing circuitry 1770 by, for example, converting the obtained information into other information, comparing the obtained information or converted information to information stored in the network node, and/or performing one or more operations based on the obtained information or converted information, and as a result of said processing making a determination.

Processing circuitry 1770 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1760 components, such as device readable medium 1780, network node 1760 functionality. For example, processing circuitry 1770 may execute instructions stored in device readable medium 1780 or in memory within processing circuitry 1770. Such functionality may include providing any of the various wireless features, functions, or benefits discussed herein. In some embodiments, processing circuitry 1770 may include a system on a chip (SOC).

In some embodiments, processing circuitry 1770 may include one or more of radio frequency (RF) transceiver circuitry 1772 and baseband processing circuitry 1774. In some embodiments, radio frequency (RF) transceiver circuitry 1772 and baseband processing circuitry 1774 may be on separate chips (or sets of chips), boards, or units, such as radio units and digital units. In alternative embodiments, part or all of RF transceiver circuitry 1772 and baseband processing circuitry 1774 may be on the same chip or set of chips, boards, or units

In certain embodiments, some or all of the functionality described herein as being provided by a network node, base station, eNB or other such network device may be performed by processing circuitry 1770 executing instructions stored on device readable medium 1780 or memory within processing circuitry 1770. In alternative embodiments, some or all of the functionality may be provided by processing circuitry 1770 without executing instructions stored on a separate or discrete device readable medium, such as in a hard-wired manner. In any of those embodiments, whether executing instructions stored on a device readable storage medium or not, processing circuitry 1770 can be configured to perform the described functionality. The benefits provided by such functionality are not limited to processing circuitry 1770 alone or to other components of network node 1760, but are enjoyed by network node 1760 as a whole, and/or by end users and the wireless network generally.

Device readable medium 1780 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 1770. Device readable medium 1780 may store any suitable instructions, data or information, including a computer program, software, an application including one or more of logic, rules, code, tables, etc. and/or other instructions capable of being executed by processing circuitry 1770 and, utilized by network node 1760. Device readable medium 1780 may be used to store any calculations made by processing circuitry 1770 and/or any data received via interface 1790. In some embodiments, processing circuitry 1770 and device readable medium 1780 may be considered to be integrated.

Interface 1790 is used in the wired or wireless communication of signalling and/or data between network node 1760, network 1706, and/or WDs 1710. As illustrated, interface 1790 comprises port(s)/terminal(s) 1794 to send and receive data, for example to and from network 1706 over a wired connection. Interface 1790 also includes radio front end circuitry 1792 that may be coupled to, or in certain embodiments a part of, antenna 1762. Radio front end circuitry 1792 comprises filters 1798 and amplifiers 1796. Radio front end circuitry 1792 may be connected to antenna 1762 and processing circuitry 1770. Radio front end circuitry may be configured to condition signals communicated between antenna 1762 and processing circuitry 1770. Radio front end circuitry 1792 may receive digital data that is to be sent out to other network nodes or WDs via a wireless connection. Radio front end circuitry 1792 may convert the digital data into a radio signal having the appropriate channel and bandwidth parameters using a combination of filters 1798 and/or amplifiers 1796. The radio signal may then be transmitted via antenna 1762. Similarly, when receiving data, antenna 1762 may collect radio signals which are then converted into digital data by radio front end circuitry 1792. The digital data may be passed to processing circuitry 1770. In other embodiments, the interface may comprise different components and/or different combinations of components.

In certain alternative embodiments, network node 1760 may not include separate radio front end circuitry 1792, instead, processing circuitry 1770 may comprise radio front end circuitry and may be connected to antenna 1762 without separate radio front end circuitry 1792. Similarly, in some embodiments, all or some of RF transceiver circuitry 1772 may be considered a part of interface 1790. In still other embodiments, interface 1790 may include one or more ports or terminals 1794, radio front end circuitry 1792, and RF transceiver circuitry 1772, as part of a radio unit (not shown), and interface 1790 may communicate with baseband processing circuitry 1774, which is part of a digital unit (not shown).

Antenna 1762 may include one or more antennas, or antenna arrays, configured to send and/or receive wireless signals. Antenna 1762 may be coupled to radio front end circuitry 1790 and may be any type of antenna capable of transmitting and receiving data and/or signals wirelessly. In some embodiments, antenna 1762 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1762 may be separate from network node 1760 and may be connectable to network node 1760 through an interface or port.

Antenna 1762, interface 1790, and/or processing circuitry 1770 may be configured to perform any receiving operations and/or certain obtaining operations described herein as being performed by a network node. Any information, data and/or signals may be received from a wireless device, another network node and/or any other network equipment. Similarly, antenna 1762, interface 1790, and/or processing circuitry 1770 may be configured to perform any transmitting operations described herein as being performed by a network node. Any information, data and/or signals may be transmitted to a wireless device, another network node and/or any other network equipment.

Power circuitry 1787 may comprise, or be coupled to, power management circuitry and is configured to supply the components of network node 1760 with power for performing the functionality described herein. Power circuitry 1787 may receive power from power source 1786. Power source 1786 and/or power circuitry 1787 may be configured to provide power to the various components of network node 1760 in a form suitable for the respective components (e.g., at a voltage and current level needed for each respective component). Power source 1786 may either be included in, or external to, power circuitry 1787 and/or network node 1760. For example, network node 1760 may be connectable to an external power source (e.g., an electricity outlet) via an input circuitry or interface such as an electrical cable, whereby the external power source supplies power to power circuitry 1787. As a further example, power source 1786 may comprise a source of power in the form of a battery or battery pack which is connected to, or integrated in, power circuitry 1787. The battery may provide backup power should the external power source fail. Other types of power sources, such as photovoltaic devices, may also be used.

Alternative embodiments of network node 1760 may include additional components beyond those shown in FIG. 17 that may be responsible for providing certain aspects of the network node's functionality, including any of the functionality described herein and/or any functionality necessary to support the subject matter described herein. For example, network node 1760 may include user interface equipment to allow input of information into network node 1760 and to allow output of information from network node 1760. This may allow a user to perform diagnostic, maintenance, repair, and other administrative functions for network node 1760.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1710 includes antenna 1711, interface 1714, processing circuitry 1720, device readable medium 1730, user interface equipment 1732, auxiliary equipment 1734, power source 1736 and power circuitry 1737. WD 1710 may include multiple sets of one or more of the illustrated components for different wireless technologies supported by WD 1710, such as, for example, GSM, WCDMA, LTE, NR, WiFi, WiMAX, NB-IoT, or Bluetooth wireless technologies, just to mention a few. These wireless technologies may be integrated into the same or different chips or set of chips as other components within WD 1710.

Antenna 1711 may include one or more antennas or antenna arrays, configured to send and/or receive wireless signals, and is connected to interface 1714. In certain alternative embodiments, antenna 1711 may be separate from WD 1710 and be connectable to WD 1710 through an interface or port. Antenna 1711, interface 1714, and/or processing circuitry 1720 may be configured to perform any receiving or transmitting operations described herein as being performed by a WD. Any information, data and/or signals may be received from a network node and/or another WD. In some embodiments, radio front end circuitry and/or antenna 1711 may be considered an interface.

As illustrated, interface 1714 comprises radio front end circuitry 1712 and antenna 1711. Radio front end circuitry 1712 comprise one or more filters 1718 and amplifiers 1716. Radio front end circuitry 1714 is connected to antenna 1711 and processing circuitry 1720, and is configured to condition signals communicated between antenna 1711 and processing circuitry 1720. Radio front end circuitry 1712 may be coupled to or a part of antenna 1711. In some embodiments, WD 1710 may not include separate radio front end circuitry 1712; rather, processing circuitry 1720 may comprise radio front end circuitry and may be connected to antenna 1711. Similarly, in some embodiments, some or all of RF transceiver circuitry 1722 may be considered a part of interface 1714. Radio front end circuitry 1712 may receive digital data that is to be sent out to other network nodes or WDs via a wireless connection. Radio front end circuitry 1712 may convert the digital data into a radio signal having the appropriate channel and bandwidth parameters using a combination of filters 1718 and/or amplifiers 1716. The radio signal may then be transmitted via antenna 1711. Similarly, when receiving data, antenna 1711 may collect radio signals which are then converted into digital data by radio front end circuitry 1712. The digital data may be passed to processing circuitry 1720. In other embodiments, the interface may comprise different components and/or different combinations of components.

Processing circuitry 1720 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1710 components, such as device readable medium 1730, WD 1710 functionality. Such functionality may include providing any of the various wireless features or benefits discussed herein. For example, processing circuitry 1720 may execute instructions stored in device readable medium 1730 or in memory within processing circuitry 1720 to provide the functionality disclosed herein.

As illustrated, processing circuitry 1720 includes one or more of RF transceiver circuitry 1722, baseband processing circuitry 1724, and application processing circuitry 1726. In other embodiments, the processing circuitry may comprise different components and/or different combinations of components. In certain embodiments processing circuitry 1720 of WD 1710 may comprise a SOC. In some embodiments, RF transceiver circuitry 1722, baseband processing circuitry 1724, and application processing circuitry 1726 may be on separate chips or sets of chips. In alternative embodiments, part or all of baseband processing circuitry 1724 and application processing circuitry 1726 may be combined into one chip or set of chips, and RF transceiver circuitry 1722 may be on a separate chip or set of chips. In still alternative embodiments, part or all of RF transceiver circuitry 1722 and baseband processing circuitry 1724 may be on the same chip or set of chips, and application processing circuitry 1726 may be on a separate chip or set of chips. In yet other alternative embodiments, part or all of RF transceiver circuitry 1722, baseband processing circuitry 1724, and application processing circuitry 1726 may be combined in the same chip or set of chips. In some embodiments, RF transceiver circuitry 1722 may be a part of interface 1714. RF transceiver circuitry 1722 may condition RF signals for processing circuitry 1720.

In certain embodiments, some or all of the functionality described herein as being performed by a WD may be provided by processing circuitry 1720 executing instructions stored on device readable medium 1730, which in certain embodiments may be a computer-readable storage medium. In alternative embodiments, some or all of the functionality may be provided by processing circuitry 1720 without executing instructions stored on a separate or discrete device readable storage medium, such as in a hard-wired manner. In any of those particular embodiments, whether executing instructions stored on a device readable storage medium or not, processing circuitry 1720 can be configured to perform the described functionality. The benefits provided by such functionality are not limited to processing circuitry 1720 alone or to other components of WD 1710, but are enjoyed by WD 1710 as a whole, and/or by end users and the wireless network generally.

Processing circuitry 1720 may be configured to perform any determining, calculating, or similar operations (e.g., certain obtaining operations) described herein as being performed by a WD. These operations, as performed by processing circuitry 1720, may include processing information obtained by processing circuitry 1720 by, for example, converting the obtained information into other information, comparing the obtained information or converted information to information stored by WD 1710, and/or performing one or more operations based on the obtained information or converted information, and as a result of said processing making a determination.

Device readable medium 1730 may be operable to store a computer program, software, an application including one or more of logic, rules, code, tables, etc. and/or other instructions capable of being executed by processing circuitry 1720. Device readable medium 1730 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1720. In some embodiments, processing circuitry 1720 and device readable medium 1730 may be considered to be integrated.

User interface equipment 1732 may provide components that allow for a human user to interact with WD 1710. Such interaction may be of many forms, such as visual, audial, tactile, etc. User interface equipment 1732 may be operable to produce output to the user and to allow the user to provide input to WD 1710. The type of interaction may vary depending on the type of user interface equipment 1732 installed in WD 1710. For example, if WD 1710 is a smart phone, the interaction may be via a touch screen; if WD 1710 is a smart meter, the interaction may be through a screen that provides usage (e.g., the number of gallons used) or a speaker that provides an audible alert (e.g., if smoke is detected). User interface equipment 1732 may include input interfaces, devices and circuits, and output interfaces, devices and circuits. User interface equipment 1732 is configured to allow input of information into WD 1710, and is connected to processing circuitry 1720 to allow processing circuitry 1720 to process the input information. User interface equipment 1732 may include, for example, a microphone, a proximity or other sensor, keys/buttons, a touch display, one or more cameras, a USB port, or other input circuitry. User interface equipment 1732 is also configured to allow output of information from WD 1710, and to allow processing circuitry 1720 to output information from WD 1710. User interface equipment 1732 may include, for example, a speaker, a display, vibrating circuitry, a USB port, a headphone interface, or other output circuitry. Using one or more input and output interfaces, devices, and circuits, of user interface equipment 1732, WD 1710 may communicate with end users and/or the wireless network, and allow them to benefit from the functionality described herein.

Auxiliary equipment 1734 is operable to provide more specific functionality which may not be generally performed by WDs. This may comprise specialized sensors for doing measurements for various purposes, interfaces for additional types of communication such as wired communications etc. The inclusion and type of components of auxiliary equipment 1734 may vary depending on the embodiment and/or scenario.

Power source 1736 may, in some embodiments, be in the form of a battery or battery pack. Other types of power sources, such as an external power source (e.g., an electricity outlet), photovoltaic devices or power cells, may also be used. WD 1710 may further comprise power circuitry 1737 for delivering power from power source 1736 to the various parts of WD 1710 which need power from power source 1736 to carry out any functionality described or indicated herein. Power circuitry 1737 may in certain embodiments comprise power management circuitry. Power circuitry 1737 may additionally or alternatively be operable to receive power from an external power source; in which case WD 1710 may be connectable to the external power source (such as an electricity outlet) via input circuitry or an interface such as an electrical power cable. Power circuitry 1737 may also in certain embodiments be operable to deliver power from an external power source to power source 1736. This may be, for example, for the charging of power source 1736. Power circuitry 1737 may perform any formatting, converting, or other modification to the power from power source 1736 to make the power suitable for the respective components of WD 1710 to which power is supplied.

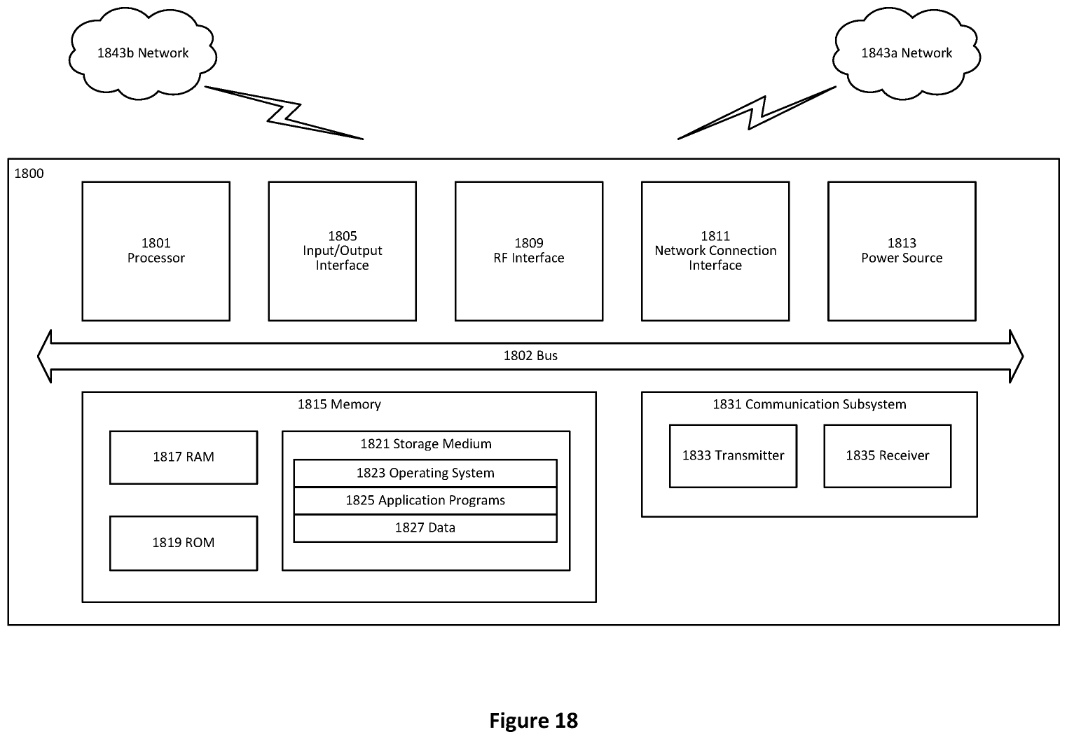

FIG. 18 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 18200 may be any UE identified by the 3^{rd} Generation Partnership Project (3GPP), including a NB-IoT UE, a machine type communication (MTC) UE, and/or an enhanced MTC (eMTC) UE. UE 1800, as illustrated in FIG. 18, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 18 is a UE, the components discussed herein are equally applicable to a WD, and vice-versa.

In FIG. 18, UE 1800 includes processing circuitry 1801 that is operatively coupled to input/output interface 1805, radio frequency (RF) interface 1809, network connection interface 1811, memory 1815 including random access memory (RAM) 1817, read-only memory (ROM) 1819, and storage medium 1821 or the like, communication subsystem 1831, power source 1833, and/or any other component, or any combination thereof. Storage medium 1821 includes operating system 1823, application program 1825, and data 1827. In other embodiments, storage medium 1821 may include other similar types of information. Certain UEs may utilize all of the components shown in FIG. 18, or only a subset of the components. The level of integration between the components may vary from one UE to another UE. Further, certain UEs may contain multiple instances of a component, such as multiple processors, memories, transceivers, transmitters, receivers, etc.

In FIG. 18, processing circuitry 1801 may be configured to process computer instructions and data. Processing circuitry 1801 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1801 may include two central processing units (CPUs). Data may be information in a form suitable for use by a computer.

In the depicted embodiment, input/output interface 1805 may be configured to provide a communication interface to an input device, output device, or input and output device. UE 1800 may be configured to use an output device via input/output interface 1805. An output device may use the same type of interface port as an input device. For example, a USB port may be used to provide input to and output from UE 1800. The output device may be a speaker, a sound card, a video card, a display, a monitor, a printer, an actuator, an emitter, a smartcard, another output device, or any combination thereof. UE 1800 may be configured to use an input device via input/output interface 1805 to allow a user to capture information into UE 1800. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 18, RF interface 1809 may be configured to provide a communication interface to RF components such as a transmitter, a receiver, and an antenna. Network connection interface 1811 may be configured to provide a communication interface to network 1843a. Network 1843a may encompass wired and/or wireless networks such as a local-area network (LAN), a wide-area network (WAN), a computer network, a wireless network, a telecommunications network, another like network or any combination thereof. For example, network 1843a may comprise a Wi-Fi network. Network connection interface 1811 may be configured to include a receiver and a transmitter interface used to communicate with one or more other devices over a communication network according to one or more communication protocols, such as Ethernet, TCP/IP, SONET, ATM, or the like. Network connection interface 1811 may implement receiver and transmitter functionality appropriate to the communication network links (e.g., optical, electrical, and the like). The transmitter and receiver functions may share circuit components, software or firmware, or alternatively may be implemented separately.

RAM 1817 may be configured to interface via bus 1802 to processing circuitry 1801 to provide storage or caching of data or computer instructions during the execution of software programs such as the operating system, application programs, and device drivers. ROM 1819 may be configured to provide computer instructions or data to processing circuitry 1801. For example, ROM 1819 may be configured to store invariant low-level system code or data for basic system functions such as basic input and output (I/O), startup, or reception of keystrokes from a keyboard that are stored in a non-volatile memory. Storage medium 1821 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1821 may be configured to include operating system 1823, application program 1825 such as a web browser application, a widget or gadget engine or another application, and data file 1827. Storage medium 1821 may store, for use by UE 1800, any of a variety of various operating systems or combinations of operating systems.

Storage medium 1821 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1821 may allow UE 1800 to access computer-executable instructions, application programs or the like, stored on transitory or non-transitory memory media, to off-load data, or to upload data. An article of manufacture, such as one utilizing a communication system may be tangibly embodied in storage medium 1821, which may comprise a device readable medium.

In FIG. 18, processing circuitry 1801 may be configured to communicate with network 1843b using communication subsystem 1831. Network 1843a and network 1843b may be the same network or networks or different network or networks. Communication subsystem 1831 may be configured to include one or more transceivers used to communicate with network 1843b. For example, communication subsystem 1831 may be configured to include one or more transceivers used to communicate with one or more remote transceivers of another device capable of wireless communication such as another WD, UE, or base station of a radio access network (RAN) according to one or more communication protocols, such as IEEE 802.18, CDMA, WCDMA, GSM, LTE, UTRAN, WMax, or the like. Each transceiver may include transmitter 1833 and/or receiver 1835 to implement transmitter or receiver functionality, respectively, appropriate to the RAN links (e.g., frequency allocations and the like). Further, transmitter 1833 and receiver 1835 of each transceiver may share circuit components, software or firmware, or alternatively may be implemented separately.

In the illustrated embodiment, the communication functions of communication subsystem 1831 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1831 may include cellular communication, Wi-Fi communication, Bluetooth communication, and GPS communication. Network 1843b may encompass wired and/or wireless networks such as a local-area network (LAN), a wide-area network (WAN), a computer network, a wireless network, a telecommunications network, another like network or any combination thereof. For example, network 1843b may be a cellular network, a Wi-Fi network, and/or a near-field network. Power source 1813 may be configured to provide alternating current (AC) or direct current (DC) power to components of UE 1800.

The features, benefits and/or functions described herein may be implemented in one of the components of UE 1800 or partitioned across multiple components of UE 1800. Further, the features, benefits, and/or functions described herein may be implemented in any combination of hardware, software or firmware. In one example, communication subsystem 1831 may be configured to include any of the components described herein. Further, processing circuitry 1801 may be configured to communicate with any of such components over bus 1802. In another example, any of such components may be represented by program instructions stored in memory that when executed by processing circuitry 1801 perform the corresponding functions described herein. In another example, the functionality of any of such components may be partitioned between processing circuitry 1801 and communication subsystem 1831. In another example, the non-computationally intensive functions of any of such components may be implemented in software or firmware and the computationally intensive functions may be implemented in hardware.

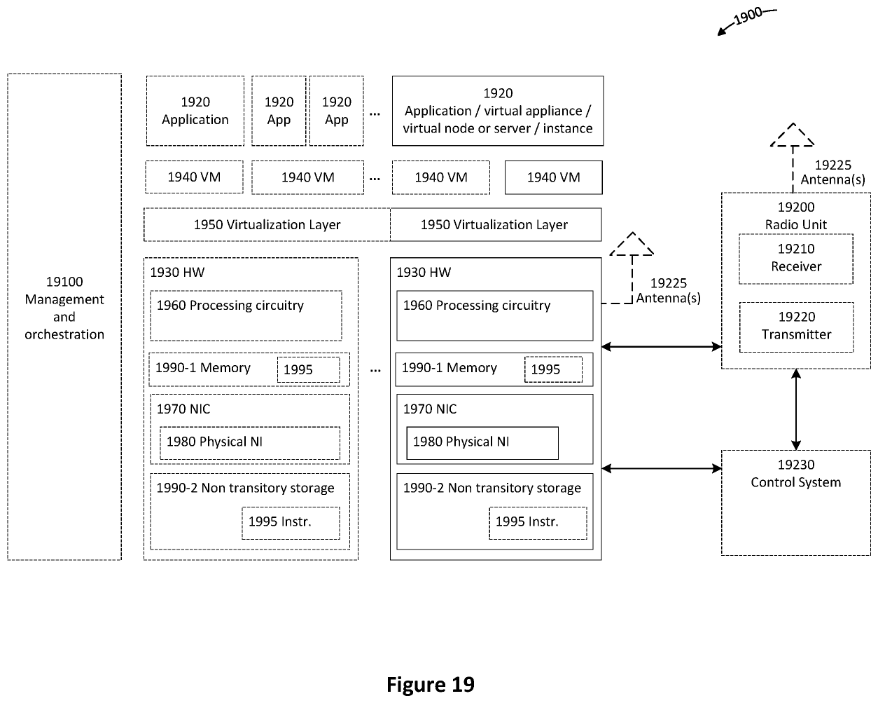

FIG. 19 is a schematic block diagram illustrating a virtualization environment 1900 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1900 hosted by one or more of hardware nodes 1930. Further, in embodiments in which the virtual node is not a radio access node or does not require radio connectivity (e.g., a core network node), then the network node may be entirely virtualized.

The functions may be implemented by one or more applications 1920 (which may alternatively be called software instances, virtual appliances, network functions, virtual nodes, virtual network functions, etc.) operative to implement some of the features, functions, and/or benefits of some of the embodiments disclosed herein. Applications 1920 are run in virtualization environment 1900 which provides hardware 1930 comprising processing circuitry 1960 and memory 1990. Memory 1990 contains instructions 1995 executable by processing circuitry 1960 whereby application 1920 is operative to provide one or more of the features, benefits, and/or functions disclosed herein.

Virtualization environment 1900, comprises general-purpose or special-purpose network hardware devices 1930 comprising a set of one or more processors or processing circuitry 1960, which may be commercial off-the-shelf (COTS) processors, dedicated Application Specific Integrated Circuits (ASICs), or any other type of processing circuitry including digital or analog hardware components or special purpose processors. Each hardware device may comprise memory 1990-1 which may be non-persistent memory for temporarily storing instructions 1995 or software executed by processing circuitry 1960. Each hardware device may comprise one or more network interface controllers (NICs) 1970, also known as network interface cards, which include physical network interface 1980. Each hardware device may also include non-transitory, persistent, machine-readable storage media 1990-2 having stored therein software 1995 and/or instructions executable by processing circuitry 1960. Software 1995 may include any type of software including software for instantiating one or more virtualization layers 1950 (also referred to as hypervisors), software to execute virtual machines 1940 as well as software allowing it to execute functions, features and/or benefits described in relation with some embodiments described herein.

Virtual machines 1940, comprise virtual processing, virtual memory, virtual networking or interface and virtual storage, and may be run by a corresponding virtualization layer 1950 or hypervisor. Different embodiments of the instance of virtual appliance 1920 may be implemented on one or more of virtual machines 1940, and the implementations may be made in different ways.

During operation, processing circuitry 1960 executes software 1995 to instantiate the hypervisor or virtualization layer 1950, which may sometimes be referred to as a virtual machine monitor (VMM). Virtualization layer 1950 may present a virtual operating platform that appears like networking hardware to virtual machine 1940.

As shown in FIG. 19, hardware 1930 may be a standalone network node with generic or specific components. Hardware 1930 may comprise antenna 19225 and may implement some functions via virtualization. Alternatively, hardware 1930 may be part of a larger cluster of hardware (e.g. such as in a data center or customer premise equipment (CPE)) where many hardware nodes work together and are managed via management and orchestration (MANO) 19100, which, among others, oversees lifecycle management of applications 1920.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1940 may be a software implementation of a physical machine that runs programs as if they were executing on a physical, non-virtualized machine. Each of virtual machines 1940, and that part of hardware 1930 that executes that virtual machine, be it hardware dedicated to that virtual machine and/or hardware shared by that virtual machine with others of the virtual machines 1940, forms a separate virtual network elements (VNE).

Still in the context of NFV, Virtual Network Function (VNF) is responsible for handling specific network functions that run in one or more virtual machines 1940 on top of hardware networking infrastructure 1930 and corresponds to application 1920 in FIG. 19.

In some embodiments, one or more radio units 19200 that each include one or more transmitters 19220 and one or more receivers 19210 may be coupled to one or more antennas 19225. Radio units 19200 may communicate directly with hardware nodes 1930 via one or more appropriate network interfaces and may be used in combination with the virtual components to provide a virtual node with radio capabilities, such as a radio access node or a base station.

In some embodiments, some signalling can be effected with the use of control system 19230 which may alternatively be used for communication between the hardware nodes 1930 and radio units 19200.

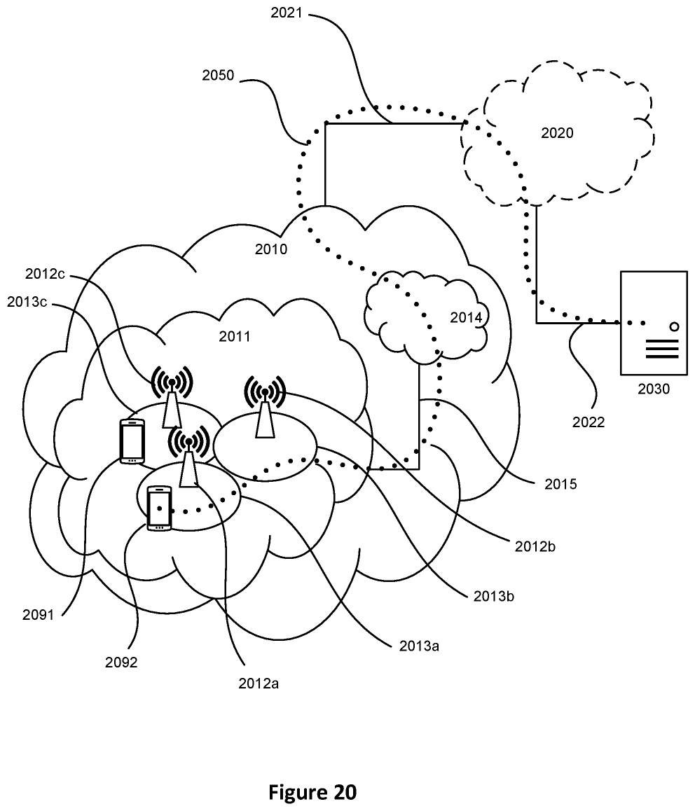

FIG. 20 illustrates a telecommunication network connected via an intermediate network to a host computer in accordance with some embodiments. In particular, with reference to FIG. 20, in accordance with an embodiment, a communication system includes telecommunication network 2010, such as a 3GPP-type cellular network, which comprises access network 2011, such as a radio access network, and core network 2014. Access network 2011 comprises a plurality of base stations 2012a, 2012b, 2012c, such as NBs, eNBs, gNBs or other types of wireless access points, each defining a corresponding coverage area 2013a, 2013b, 2013c. Each base station 2012a, 2012b, 2012c is connectable to core network 2014 over a wired or wireless connection 2015. A first UE 2091 located in coverage area 2013c is configured to wirelessly connect to, or be paged by, the corresponding base station 2012c. A second UE 2092 in coverage area 2013a is wirelessly connectable to the corresponding base station 2012a. While a plurality of UEs 2091, 2092 are illustrated in this example, the disclosed embodiments are equally applicable to a situation where a sole UE is in the coverage area or where a sole UE is connecting to the corresponding base station 2012.

Telecommunication network 2010 is itself connected to host computer 2030, which may be embodied in the hardware and/or software of a standalone server, a cloud-implemented server, a distributed server or as processing resources in a server farm. Host computer 2030 may be under the ownership or control of a service provider, or may be operated by the service provider or on behalf of the service provider. Connections 2021 and 2022 between telecommunication network 2010 and host computer 2030 may extend directly from core network 2014 to host computer 2030 or may go via an optional intermediate network 2020. Intermediate network 2020 may be one of, or a combination of more than one of, a public, private or hosted network; intermediate network 2020, if any, may be a backbone network or the Internet; in particular, intermediate network 2020 may comprise two or more sub-networks (not shown).

The communication system of FIG. 20 as a whole enables connectivity between the connected UEs 2091, 2092 and host computer 2030. The connectivity may be described as an over-the-top (OTT) connection 2050. Host computer 2030 and the connected UEs 2091, 2092 are configured to communicate data and/or signaling via OTT connection 2050, using access network 2011, core network 2014, any intermediate network 2020 and possible further infrastructure (not shown) as intermediaries. OTT connection 2050 may be transparent in the sense that the participating communication devices through which OTT connection 2050 passes are unaware of routing of uplink and downlink communications. For example, base station 2012 may not or need not be informed about the past routing of an incoming downlink communication with data originating from host computer 2030 to be forwarded (e.g., handed over) to a connected UE 2091. Similarly, base station 2012 need not be aware of the future routing of an outgoing uplink communication originating from the UE 2091 towards the host computer 2030.

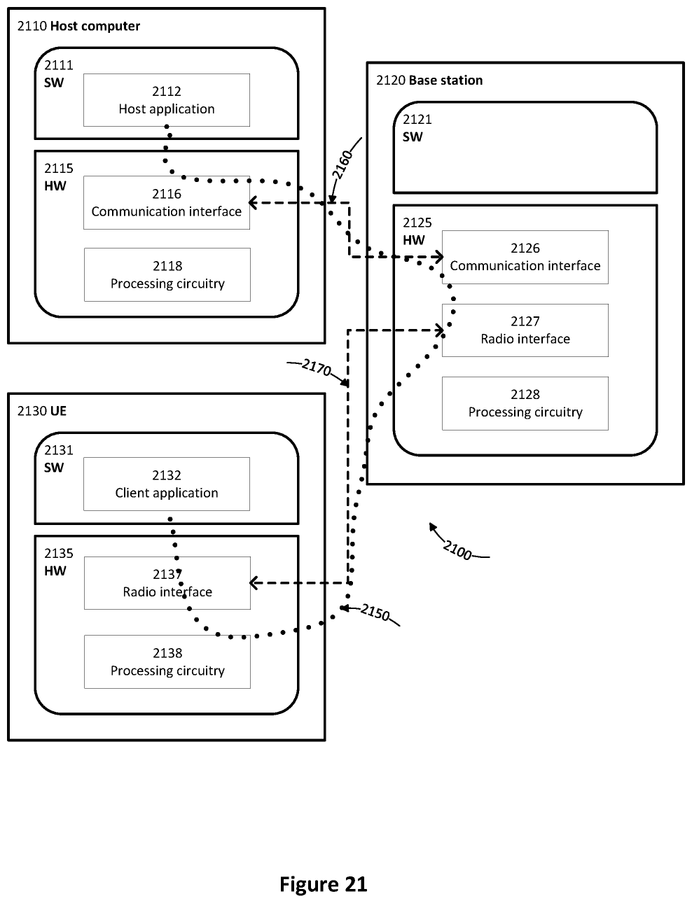

Example implementations, in accordance with an embodiment, of the UE, base station and host computer discussed in the preceding paragraphs will now be described with reference to FIG. 21. FIG. 21 illustrates host computer communicating via a base station with a user equipment over a partially wireless connection in accordance with some embodiments In communication system 2100, host computer 2110 comprises hardware 2115 including communication interface 2116 configured to set up and maintain a wired or wireless connection with an interface of a different communication device of communication system 2100. Host computer 2110 further comprises processing circuitry 2118, which may have storage and/or processing capabilities. In particular, processing circuitry 2118 may comprise one or more programmable processors, application-specific integrated circuits, field programmable gate arrays or combinations of these (not shown) adapted to execute instructions. Host computer 2110 further comprises software 2111, which is stored in or accessible by host computer 2110 and executable by processing circuitry 2118. Software 2111 includes host application 2112. Host application 2112 may be operable to provide a service to a remote user, such as UE 2130 connecting via OTT connection 2150 terminating at UE 2130 and host computer 2110. In providing the service to the remote user, host application 2112 may provide user data which is transmitted using OTT connection 2150.

Communication system 2100 further includes base station 2120 provided in a telecommunication system and comprising hardware 2125 enabling it to communicate with host computer 2110 and with UE 2130. Hardware 2125 may include communication interface 2126 for setting up and maintaining a wired or wireless connection with an interface of a different communication device of communication system 2100, as well as radio interface 2127 for setting up and maintaining at least wireless connection 2170 with UE 2130 located in a coverage area (not shown in FIG. 21) served by base station 2120. Communication interface 2126 may be configured to facilitate connection 2160 to host computer 2110. Connection 2160 may be direct or it may pass through a core network (not shown in FIG. 21) of the telecommunication system and/or through one or more intermediate networks outside the telecommunication system. In the embodiment shown, hardware 2125 of base station 2120 further includes processing circuitry 2128, which may comprise one or more programmable processors, application-specific integrated circuits, field programmable gate arrays or combinations of these (not shown) adapted to execute instructions. Base station 2120 further has software 2121 stored internally or accessible via an external connection.

Communication system 2100 further includes UE 2130 already referred to. Its hardware 2135 may include radio interface 2137 configured to set up and maintain wireless connection 2170 with a base station serving a coverage area in which UE 2130 is currently located. Hardware 2135 of UE 2130 further includes processing circuitry 2138, which may comprise one or more programmable processors, application-specific integrated circuits, field programmable gate arrays or combinations of these (not shown) adapted to execute instructions. UE 2130 further comprises software 2131, which is stored in or accessible by UE 2130 and executable by processing circuitry 2138. Software 2131 includes client application 2132. Client application 2132 may be operable to provide a service to a human or non-human user via UE 2130, with the support of host computer 2110. In host computer 2110, an executing host application 2112 may communicate with the executing client application 2132 via OTT connection 2150 terminating at UE 2130 and host computer 2110. In providing the service to the user, client application 2132 may receive request data from host application 2112 and provide user data in response to the request data. OTT connection 2150 may transfer both the request data and the user data. Client application 2132 may interact with the user to generate the user data that it provides.

It is noted that host computer 2110, base station 2120 and UE 2130 illustrated in FIG. 21 may be similar or identical to host computer 2030, one of base stations 2012a, 2012b, 2012c and one of UEs 2091, 2092 of FIG. 20, respectively. This is to say, the inner workings of these entities may be as shown in FIG. 21 and independently, the surrounding network topology may be that of FIG. 20.

In FIG. 21, OTT connection 2150 has been drawn abstractly to illustrate the communication between host computer 2110 and UE 2130 via base station 2120, without explicit reference to any intermediary devices and the precise routing of messages via these devices. Network infrastructure may determine the routing, which it may be configured to hide from UE 2130 or from the service provider operating host computer 2110, or both. While OTT connection 2150 is active, the network infrastructure may further take decisions by which it dynamically changes the routing (e.g., on the basis of load balancing consideration or reconfiguration of the network).

Wireless connection 2170 between UE 2130 and base station 2120 is in accordance with the teachings of the embodiments described throughout this disclosure. One or more of the various embodiments improve the performance of OTT services provided to UE 2130 using OTT connection 2150, in which wireless connection 2170 forms the last segment. More precisely, the teachings of these embodiments may improve the robustness of handover performance and thereby provide benefits such as fewer dropped calls and better responsiveness.

A measurement procedure may be provided for the purpose of monitoring data rate, latency and other factors on which the one or more embodiments improve. There may further be an optional network functionality for reconfiguring OTT connection 2150 between host computer 2110 and UE 2130, in response to variations in the measurement results. The measurement procedure and/or the network functionality for reconfiguring OTT connection 2150 may be implemented in software 2111 and hardware 2115 of host computer 2110 or in software 2131 and hardware 2135 of UE 2130, or both. In embodiments, sensors (not shown) may be deployed in or in association with communication devices through which OTT connection 2150 passes; the sensors may participate in the measurement procedure by supplying values of the monitored quantities exemplified above, or supplying values of other physical quantities from which software 2111, 2131 may compute or estimate the monitored quantities. The reconfiguring of OTT connection 2150 may include message format, retransmission settings, preferred routing etc.; the reconfiguring need not affect base station 2120, and it may be unknown or imperceptible to base station 2120. Such procedures and functionalities may be known and practiced in the art. In certain embodiments, measurements may involve proprietary UE signaling facilitating host computer 2110's measurements of throughput, propagation times, latency and the like. The measurements may be implemented in that software 2111 and 2131 causes messages to be transmitted, in particular empty or ‘dummy’ messages, using OTT connection 2150 while it monitors propagation times, errors etc.

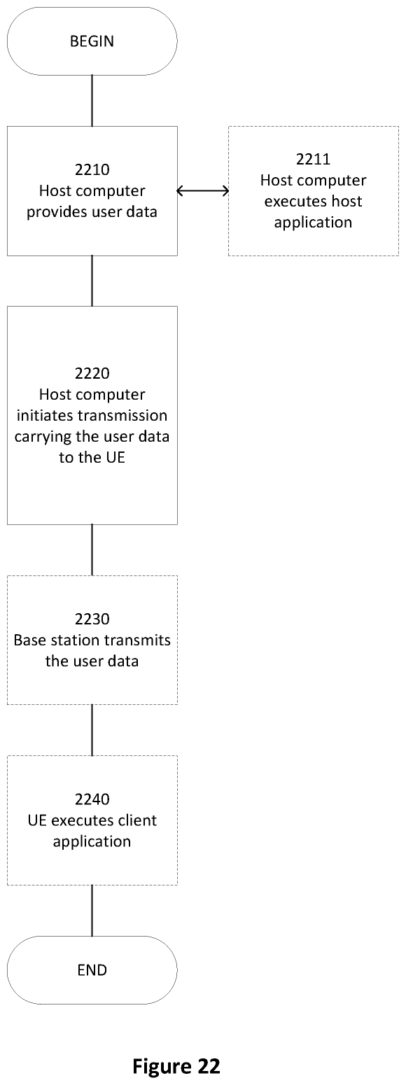

FIG. 22 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 22 will be included in this section. In step 2210, the host computer provides user data. In substep 2211 (which may be optional) of step 2210, the host computer provides the user data by executing a host application. In step 2220, the host computer initiates a transmission carrying the user data to the UE. In step 2230 (which may be optional), the base station transmits to the UE the user data which was carried in the transmission that the host computer initiated, in accordance with the teachings of the embodiments described throughout this disclosure. In step 2240 (which may also be optional), the UE executes a client application associated with the host application executed by the host computer.

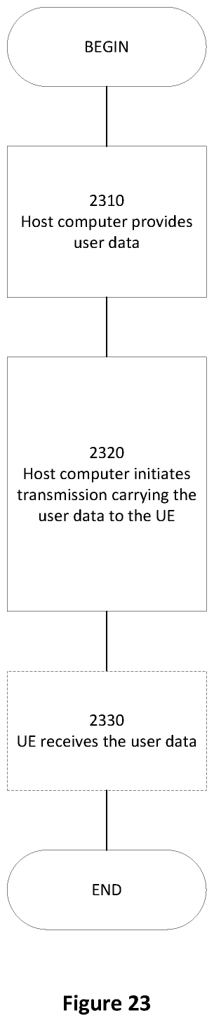

FIG. 23 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 23 will be included in this section. In step 2310 of the method, the host computer provides user data. In an optional substep (not shown) the host computer provides the user data by executing a host application. In step 2320, the host computer initiates a transmission carrying the user data to the UE. The transmission may pass via the base station, in accordance with the teachings of the embodiments described throughout this disclosure. In step 2330 (which may be optional), the UE receives the user data carried in the transmission.

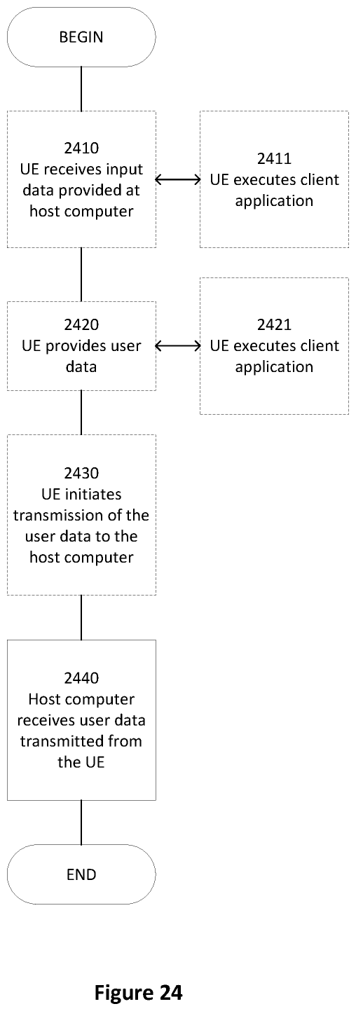

FIG. 24 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 24 will be included in this section. In step 2410 (which may be optional), the UE receives input data provided by the host computer. Additionally or alternatively, in step 2420, the UE provides user data. In substep 2421 (which may be optional) of step 2420, the UE provides the user data by executing a client application. In substep 2411 (which may be optional) of step 2410, the UE executes a client application which provides the user data in reaction to the received input data provided by the host computer. In providing the user data, the executed client application may further consider user input received from the user. Regardless of the specific manner in which the user data was provided, the UE initiates, in substep 2430 (which may be optional), transmission of the user data to the host computer. In step 2440 of the method, the host computer receives the user data transmitted from the UE, in accordance with the teachings of the embodiments described throughout this disclosure.

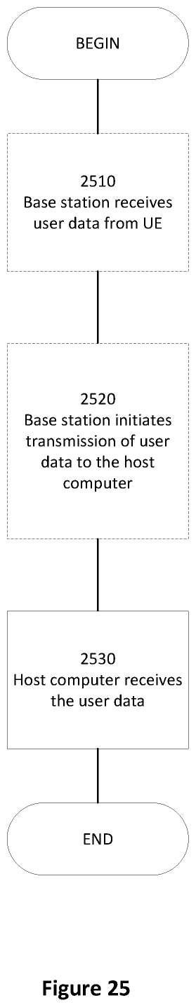

FIG. 25 is a flowchart illustrating a method implemented in a communication system, in accordance with one embodiment. The communication system includes a host computer, a base station and a UE which may be those described with reference to FIGS. 20 and 21. For simplicity of the present disclosure, only drawing references to FIG. 25 will be included in this section. In step 2510 (which may be optional), in accordance with the teachings of the embodiments described throughout this disclosure, the base station receives user data from the UE. In step 2520 (which may be optional), the base station initiates transmission of the received user data to the host computer. In step 2530 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the description.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Some of the embodiments contemplated herein are described more fully with reference to the accompanying drawings. Other embodiments, however, are contained within the scope of the subject matter disclosed herein. The disclosed subject matter should not be construed as limited to only the embodiments set forth herein; rather, these embodiments are provided by way of example to convey the scope of the subject matter to those skilled in the art.

Some embodiments herein are nonetheless enumerated below by way of example.

### GROUP A EMBODIMENTS

### Embodiment A1

A method performed by a wireless device configured for use in a wireless communication network, the method comprising: receiving from network equipment signaling that indicates a ranking of target links to which the wireless device is commanded to conditionally perform a link switch.

### Embodiment A2

The method of embodiment A1, further comprising, responsive to detecting fulfillment of one or more conditions for performing a link switch to any of certain ones of the target links, attempting to perform a link switch to one or more of the certain target links in order of the indicated ranking.

### Embodiment A3

The method of any of embodiments A1-A2, wherein the signaling indicating the ranking of the target links is included in one or more conditional link switch commands that command the wireless device to conditionally perform the link switch to the target links.

### Embodiment A4

The method of any of embodiments A1-A2, wherein the signaling indicating the ranking of the target links to which the wireless device is commanded to conditionally perform a link switch comprises signaling indicating a ranking of a set of potential target links and signaling indicating which of the potential target links are target links to which the wireless device is commanded to conditionally perform a link switch.

### Embodiment AA

The method of any of the previous embodiments, further comprising: providing user data; and forwarding the user data to a host computer via the transmission to the base station.

### GROUP B EMBODIMENTS

### Embodiment B5

A method performed by network equipment configured for use in a wireless communication network, the method comprising: transmitting to a wireless device signaling that indicates a ranking of target links to which the wireless device is commanded to conditionally perform a link switch.

### Embodiment B6

The method of embodiment B5, further comprising: responsive to receiving a measurement report from the wireless device, determining a set of target links to evaluate as candidates for commanding the wireless device to conditionally perform a link switch; determining a ranking of the target links in the set; deciding, based on the determined ranking, to which of the target links in the set the network equipment is to command the wireless device to conditionally perform a link switch; and transmitting to the wireless device signaling, in accordance with said deciding, indicating target links to which the wireless device is commanded to conditionally perform a link switch.

### Embodiment B7

The method of embodiment B6, further comprising: before determining the ranking of the target links in the set, preparing each of the target links in the set for the link switch by transmitting a link switch request to each of one or more network equipment providing the target links; and after said deciding based on the determined ranking, transmitting release signaling to any network equipment providing a target link to which the wireless device is not to be commanded to perform a conditional link switch, the release signaling indicating to release any resources prepared for a link switch to the target link.

### Embodiment B8

The method of embodiment B7, further comprising determining the ranking of the target links in the set based, at least in part, on information received from each of the one or more network equipment in response to the link switch request transmitted to that network equipment.

### Embodiment B9

The method of embodiment B8, wherein the information received from each of the one or more network equipment includes information about resources prepared for a link switch to a target link provided by that network equipment.

### Embodiment B10

The method of any of embodiments B8-B9, further comprising determining the ranking of the target links.

### Embodiment B11

The method of embodiment B10, comprising determining the ranking of the target links based on, for each of one or more of the target links, a rank of the target link received from network equipment providing that target link.

### Embodiment B12

The method of any of embodiments B10-B11, comprising determining the ranking of the target links based on current or expected loading on each of the target links.

### Embodiment B13

The method of any of embodiments B10-B12, comprising determining the ranking of the target links based on a type or coverage area size of each of the target links.

### Embodiment B14

The method of any of embodiments B10-B13, comprising determining the ranking of the target links based on statistics describing historical success or failure of link switches to each of the target links.

### Embodiment B15

The method of any of embodiments B10-B14, comprising determining the ranking of the target links based on a type of random access resources provided by each of the target links and/or a validity timer of resources provided by each of the target links.

### Embodiment B16

The method of any of embodiments B6-B15, wherein the signaling indicating the ranking of the target links is included in one or more conditional link switch commands that command the wireless device to conditionally perform the link switch to the target links.

### Embodiment B17

The method of any of embodiments B6-B15, wherein the signaling indicating the ranking of the target links to which the wireless device is commanded to conditionally perform a link switch comprises signaling indicating a ranking of a set of potential target links and signaling indicating which of the potential target links are target links to which the wireless device is commanded to conditionally perform a link switch.

### Embodiment B18

A method performed by source network equipment configured for providing a source link in a wireless communication network, the method comprising: transmitting to target network equipment providing a target link a link switch request that includes a rank of that target link in a ranking of target links to which a wireless device is to be commanded to conditionally perform a link switch.

### Embodiment B19

A method performed by target network equipment configured for providing a target link in a wireless communication network, the method comprising: receiving, from network equipment providing a source link, a link switch request that includes a rank of the target link in a ranking of target links to which a wireless device is to be commanded to conditionally perform a link switch.

### Embodiment B20

The method of embodiment B19, further comprising allocating random access radio resources on the target link based on the rank of the target link.

### Embodiment B21

The method of any of embodiments B19-B20, further comprising determining whether to allocate contention-free random access radio resources on the target link, based on a rank of the target link.

### Embodiment B22

The method of any of embodiments B19-B21, further comprising determining how many contention-free random access radio resources on the target link to allocate, in dependence on a rank of the target link.

### Embodiment B23

A method performed by target network equipment configured for use in a wireless communication network, the method comprising: receiving a link switch request that requests the target network equipment to prepare for a link switch to a target link provided by the target network equipment; and responsive to the link switch request, transmitting, to source network equipment providing a source link, a rank of the target link for the link switch.

### Embodiment B24

The method of embodiment B23, further comprising determining the rank of the target link based on current or expected loading on the target link.

### Embodiment B25

The method of any of embodiments B23-B24, comprising determining the rank of the target link based on a type or coverage area size of the target link.

### Embodiment B26

The method of any of embodiments B23-B25, comprising determining the rank of the target link based on statistics describing historical success or failure of link switches to the target link.

### Embodiment B27

A method performed by source network equipment configured for use in a wireless communication network, the method comprising: transmitting a link switch request that requests target network equipment to prepare for a link switch to a target link provided by the target network equipment; and responsive to the link switch request, receiving, from the target network equipment, a rank of the target link for the link switch.

### Embodiment BB

The method of any of the previous embodiments, further comprising: obtaining user data; and forwarding the user data to a host computer or a wireless device.

### GROUP C EMBODIMENTS

### Embodiment C1

A wireless device configured to perform any of the steps of any of the Group A embodiments.

### Embodiment C2

A wireless device comprising: processing circuitry configured to perform any of the steps of any of the Group A embodiments; and power supply circuitry configured to supply power to the wireless device.

### Embodiment C3

A wireless device comprising: processing circuitry and memory, the memory containing instructions executable by the processing circuitry whereby the wireless device is configured to perform any of the steps of any of the Group A embodiments.

### Embodiment C4

A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

### Embodiment C5

A computer program comprising instructions which, when executed by at least one processor of a wireless device, causes the wireless device to carry out the steps of any of the Group A embodiments.

### Embodiment C6

A carrier containing the computer program of embodiment C5, wherein the carrier is one of an electronic signal, optical signal, radio signal, or computer readable storage medium.

### Embodiment C7

A base station configured to perform any of the steps of any of the Group B embodiments.

### Embodiment C8

A base station comprising: processing circuitry configured to perform any of the steps of any of the Group B embodiments; power supply circuitry configured to supply power to the wireless device.

### Embodiment C9

A base station comprising: processing circuitry and memory, the memory containing instructions executable by the processing circuitry whereby the base station is configured to perform any of the steps of any of the Group B embodiments.

### Embodiment C10

A computer program comprising instructions which, when executed by at least one processor of a base station, causes the base station to carry out the steps of any of the Group B embodiments.

### Embodiment C11

A carrier containing the computer program of embodiment C10, wherein the carrier is one of an electronic signal, optical signal, radio signal, or computer readable storage medium.

### GROUP D EMBODIMENTS

### Embodiment D1

A communication system including a host computer comprising: processing circuitry configured to provide user data; and a communication interface configured to forward the user data to a cellular network for transmission to a user equipment (UE), wherein the cellular network comprises a base station having a radio interface and processing circuitry, the base station's processing circuitry configured to perform any of the steps of any of the Group B embodiments.

### Embodiment D2

The communication system of the pervious embodiment further including the base station.

### Embodiment D3

The communication system of the previous 2 embodiments, further including the UE, wherein the UE is configured to communicate with the base station.

### Embodiment D4

The communication system of the previous 3 embodiments, wherein: the processing circuitry of the host computer is configured to execute a host application, thereby providing the user data; and the UE comprises processing circuitry configured to execute a client application associated with the host application.

### Embodiment D5

A method implemented in a communication system including a host computer, a base station and a user equipment (UE), the method comprising: at the host computer, providing user data; and at the host computer, initiating a transmission carrying the user data to the UE via a cellular network comprising the base station, wherein the base station performs any of the steps of any of the Group B embodiments.

### Embodiment D6

The method of the previous embodiment, further comprising, at the base station, transmitting the user data.

### Embodiment D7

The method of the previous 2 embodiments, wherein the user data is provided at the host computer by executing a host application, the method further comprising, at the UE, executing a client application associated with the host application.

### Embodiment D8

A user equipment (UE) configured to communicate with a base station, the UE comprising a radio interface and processing circuitry configured to perform any of the previous 3 embodiments.

### Embodiment D9

A communication system including a host computer comprising: processing circuitry configured to provide user data; and a communication interface configured to forward user data to a cellular network for transmission to a user equipment (UE), wherein the UE comprises a radio interface and processing circuitry, the UE's components configured to perform any of the steps of any of the Group A embodiments.

### Embodiment D10

The communication system of the previous embodiment, wherein the cellular network further includes a base station configured to communicate with the UE.

### Embodiment D11

The communication system of the previous 2 embodiments, wherein: the processing circuitry of the host computer is configured to execute a host application, thereby providing the user data; and the UE's processing circuitry is configured to execute a client application associated with the host application.

### Embodiment D12

A method implemented in a communication system including a host computer, a base station and a user equipment (UE), the method comprising: at the host computer, providing user data; and at the host computer, initiating a transmission carrying the user data to the UE via a cellular network comprising the base station, wherein the UE performs any of the steps of any of the Group A embodiments.

### Embodiment D13

The method of the previous embodiment, further comprising at the UE, receiving the user data from the base station.

### Embodiment D14

A communication system including a host computer comprising: communication interface configured to receive user data originating from a transmission from a user equipment (UE) to a base station, wherein the UE comprises a radio interface and processing circuitry, the UE's processing circuitry configured to perform any of the steps of any of the Group A embodiments.

### Embodiment D15

The communication system of the previous embodiment, further including the UE.

### Embodiment D16

The communication system of the previous 2 embodiments, further including the base station, wherein the base station comprises a radio interface configured to communicate with the UE and a communication interface configured to forward to the host computer the user data carried by a transmission from the UE to the base station.

### Embodiment D17

The communication system of the previous 3 embodiments, wherein: the processing circuitry of the host computer is configured to execute a host application; and the UE's processing circuitry is configured to execute a client application associated with the host application, thereby providing the user data.

### Embodiment D18

The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

### Embodiment D19

A method implemented in a communication system including a host computer, a base station and a user equipment (UE), the method comprising: at the host computer, receiving user data transmitted to the base station from the UE, wherein the UE performs any of the steps of any of the Group A embodiments.

### Embodiment D20

The method of the previous embodiment, further comprising, at the UE, providing the user data to the base station.

### Embodiment D21

The method of the previous 2 embodiments, further comprising: at the UE, executing a client application, thereby providing the user data to be transmitted; and at the host computer, executing a host application associated with the client application.

### Embodiment D22

The method of the previous 3 embodiments, further comprising: at the UE, executing a client application; and at the UE, receiving input data to the client application, the input data being provided at the host computer by executing a host application associated with the client application, wherein the user data to be transmitted is provided by the client application in response to the input data.

### Embodiment D23

A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

### Embodiment D24

The communication system of the previous embodiment further including the base station.

### Embodiment D25

The communication system of the previous 2 embodiments, further including the UE, wherein the UE is configured to communicate with the base station.

### Embodiment D26

The communication system of the previous 3 embodiments, wherein: the processing circuitry of the host computer is configured to execute a host application; the UE is configured to execute a client application associated with the host application, thereby providing the user data to be received by the host computer.

### Embodiment D27

A method implemented in a communication system including a host computer, a base station and a user equipment (UE), the method comprising: at the host computer, receiving, from the base station, user data originating from a transmission which the base station has received from the UE, wherein the UE performs any of the steps of any of the Group A embodiments.

### Embodiment D28

The method of the previous embodiment, further comprising at the base station, receiving the user data from the UE.

### Embodiment D29

The method of the previous 2 embodiments, further comprising at the base station, initiating a transmission of the received user data to the host computer.

### GROUP E EMBODIMENTS

### Embodiment E1

A method performed by a wireless device configured for use in a wireless communication network, the method comprising: in connected mode, attempting to access one or more target links in order of a ranking of multiple target links that are candidates for the wireless device to access.

### Embodiment E2

The method of embodiment E1, wherein the attempting comprises attempting to access a lower ranked target link only after an attempt to access a higher ranked target link has failed.

### Embodiment E3

The method of embodiment E1, wherein the attempting comprises attempting to access a lower ranked target link after attempting to access a higher ranked target link, but before that attempt is deemed to have succeeded or failed.

### Embodiment E4

The method of any of embodiments E1-E3, wherein attempting to access a target link comprises transmitting a random access preamble for random access to the target link.

### Embodiment E5

The method of any of embodiments E1-E4, wherein attempting to access a target link comprises attempting to access a target link using carrier aggregation or dual connectivity.

### Embodiment E6

The method of any of embodiments E1-E4, wherein the target links are candidates for the wireless device to switch to accessing via a link switch to be performed in the connected mode.

### Embodiment E7

The method of embodiment E6, wherein the attempting comprises attempting to perform the link switch in the connected mode to one or more of the target links in order of the ranking.

### Embodiment E8

The method of any of embodiments E6-E7, wherein the link switch is a conditional link switch.

### Embodiment E9

The method of embodiment E8, wherein the conditional link switch is a conditional handover.

### Embodiment E10

The method of any of embodiments E1-E9, further comprising receiving from the wireless communication network information based on which the wireless device determines the ranking.

### Embodiment E11

The method of embodiment E10, wherein the target links are candidates for the wireless device to switch to accessing via a link switch to be performed in the connected mode, and wherein the information is received in one or more commands to perform the link switch.

### Embodiment E12

The method of any of embodiments E10-E11, wherein the information includes an ordering of the multiple target links in a list provided in one or more messages from the wireless communication network.

### Embodiment E13

The method of any of embodiments E10-E12, wherein the information includes a random access channel configuration associated with each of the target links.

### Embodiment E14

The method of any of embodiments E10-E13, wherein the information includes, for each of the target links, whether random access channel resources allocated for accessing the target link are contention-free or contention-based.

### Embodiment E15

The method of any of embodiments E10-E14, wherein the information includes, for each of the target links, whether random access channel resources allocated for accessing the target link are mapped to a synchronization signal block (SSB) or channel state information reference signal (CSI-RS) resources.

### Embodiment E16

The method of any of embodiments E10-E11, wherein the information explicitly indicates the ranking.

### Embodiment E17

The method of any of embodiments E10-E11 and E16, wherein the information indicates a ranking of a set of potential target links and indicates which of the potential target links are candidates for the wireless device is to access.

### Embodiment E18

The method of any of embodiments E10-E11 and E16-E17, wherein the target links are candidates for the wireless device to switch to accessing via a conditional link switch to be performed in the connected mode, wherein the information includes signaling indicating a ranking of a set of potential target links and signaling indicating which of the potential target links are target links to which the wireless device is commanded to conditionally perform a link switch.

### Embodiment E19

The method of any of embodiments E1-E9, further comprising transmitting to the wireless communication network information based on which the wireless device determines the ranking.

### Embodiment E20

The method of embodiment E19, wherein the information includes results of measurements performed on the target links.

### Embodiment E21

The method of any of embodiments E1-E20, wherein the ranking is according to one or more rules commonly defined at the wireless device and in the wireless communication network.

### Embodiment EE

The method of any of the previous embodiments, further comprising: providing user data; and forwarding the user data to a host computer via the transmission to the base station.

### GROUP F EMBODIMENTS

### Embodiment F1

A method performed by network equipment configured for use in a wireless communication network, the method comprising: transmitting to a wireless device information explicitly or implicitly indicating a ranking of multiple target links that are candidates for the wireless device to access in connected mode.

### Embodiment F2

The method of embodiment F1, wherein the multiple target links are candidates for the wireless device to access in connected mode using carrier aggregation or dual connectivity.

### Embodiment F3

The method of any of embodiments F1-F2, wherein the information indicates a ranking of a set of potential target links and indicates which of the potential target links are candidates for the wireless device is to access.

### Embodiment F4

The method of any of embodiments F1-F3, wherein the target links are candidates for the wireless device to switch to accessing via a conditional link switch to be performed in the connected mode, wherein the information includes signaling indicating a ranking of a set of potential target links and signaling indicating which of the potential target links are target links to which the wireless device is commanded to conditionally perform a link switch.

### Embodiment F5

The method of embodiment F1, wherein the target links are candidates for the wireless device to switch to accessing via a link switch to be performed in the connected mode.

### Embodiment F6

The method of embodiment F5, wherein the link switch is a conditional link switch.

### Embodiment F7

The method of embodiment F6, wherein the conditional link switch is a conditional handover.

### Embodiment F8

The method of any of embodiments F6-F7, further comprising: responsive to receiving a measurement report from the wireless device, determining a set of target links to evaluate as candidates for commanding the wireless device to conditionally perform a link switch; determining a ranking of the target links in the set; deciding, based on the determined ranking, to which of the target links in the set the network equipment is to command the wireless device to conditionally perform a link switch; and transmitting to the wireless device signaling, in accordance with said deciding, indicating target links to which the wireless device is commanded to conditionally perform a link switch.

### Embodiment F9

The method of embodiment F8, further comprising: before determining the ranking of the target links in the set, preparing each of the target links in the set for the link switch by transmitting a link switch request to each of one or more network equipment providing the target links; and after said deciding based on the determined ranking, transmitting release signaling to any network equipment providing a target link to which the wireless device is not to be commanded to perform a conditional link switch, the release signaling indicating to release any resources prepared for a link switch to the target link.

### Embodiment F10

The method of embodiment F9, further comprising determining the ranking of the target links in the set based, at least in part, on information received from each of the one or more network equipment in response to the link switch request transmitted to that network equipment.

### Embodiment F11

The method of embodiment F10, wherein the information received from each of the one or more network equipment includes information about resources prepared for a link switch to a target link provided by that network equipment.

### Embodiment F12

The method of any of embodiments F1-F11, further comprising determining the ranking of the target links.

### Embodiment F13

The method of embodiment F12, comprising determining the ranking of the target links based on, for each of one or more of the target links, a rank of the target link received from network equipment providing that target link.

### Embodiment F14

The method of any of embodiments F12-F13, comprising determining the ranking of the target links based on current or expected loading on each of the target links.

### Embodiment F15

The method of any of embodiments F12-F14, comprising determining the ranking of the target links based on a type or coverage area size of each of the target links.

### Embodiment F16

The method of any of embodiments F12-F15, comprising determining the ranking of the target links based on statistics describing historical success or failure of attempts to access each of the target links.

### Embodiment F17

The method of any of embodiments F12-F16, comprising determining the ranking of the target links based on a type of random access resources provided by each of the target links and/or a validity timer of resources provided by each of the target links.

### Embodiment F18

A method performed by source network equipment configured for providing a source link in a wireless communication network, the method comprising: transmitting, to target network equipment providing a target link, information indicating a rank of that target link in a ranking of target links that are candidates for a wireless device to access in connected mode.

### Embodiment F19

A method performed by target network equipment configured for providing a target link in a wireless communication network, the method comprising: receiving, from network equipment providing a source link, information indicating a rank of that target link in a ranking of target links that are candidates for a wireless device to access in connected mode.

### Embodiment F20

The method of embodiment F19, further comprising allocating random access radio resources on the target link based on the rank of the target link.

### Embodiment F21

The method of any of embodiments F19-F20, further comprising determining whether to allocate contention-free random access radio resources on the target link, based on a rank of the target link.

### Embodiment F22

The method of any of embodiments F19-F21, further comprising determining how many contention-free random access radio resources on the target link to allocate, in dependence on a rank of the target link.

### Embodiment FF

The method of any of the previous embodiments, further comprising: obtaining user data; and forwarding the user data to a host computer or a wireless device.

### GROUP G EMBODIMENTS

### Embodiment G1

A wireless device configured to perform any of the steps of any of the Group E embodiments.

### Embodiment G2

A wireless device comprising: processing circuitry configured to perform any of the steps of any of the Group E embodiments; and power supply circuitry configured to supply power to the wireless device.

### Embodiment G3

A wireless device comprising: processing circuitry and memory, the memory containing instructions executable by the processing circuitry whereby the wireless device is configured to perform any of the steps of any of the Group E embodiments.

### Embodiment G4

A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group E embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

### Embodiment G5

A computer program comprising instructions which, when executed by at least one processor of a wireless device, causes the wireless device to carry out the steps of any of the Group E embodiments.

### Embodiment G6

A carrier containing the computer program of embodiment G5, wherein the carrier is one of an electronic signal, optical signal, radio signal, or computer readable storage medium.

### Embodiment G7

A base station configured to perform any of the steps of any of the Group F embodiments.

### Embodiment G8

A base station comprising: processing circuitry configured to perform any of the steps of any of the Group F embodiments; power supply circuitry configured to supply power to the wireless device.

### Embodiment G9

A base station comprising: processing circuitry and memory, the memory containing instructions executable by the processing circuitry whereby the base station is configured to perform any of the steps of any of the Group F embodiments.

### Embodiment G10

A computer program comprising instructions which, when executed by at least one processor of a base station, causes the base station to carry out the steps of any of the Group F embodiments.

### Embodiment G11

A carrier containing the computer program of embodiment G10, wherein the carrier is one of an electronic signal, optical signal, radio signal, or computer readable storage medium.

### GROUP H EMBODIMENTS

### Embodiment H1

A communication system including a host computer comprising: processing circuitry configured to provide user data; and a communication interface configured to forward the user data to a cellular network for transmission to a user equipment (UE), wherein the cellular network comprises a base station having a radio interface and processing circuitry, the base station's processing circuitry configured to perform any of the steps of any of the Group F embodiments.

### Embodiment H2

The communication system of the pervious embodiment further including the base station.

### Embodiment H3

The communication system of the previous 2 embodiments, further including the UE, wherein the UE is configured to communicate with the base station.

### Embodiment H4

The communication system of the previous 3 embodiments, wherein: the processing circuitry of the host computer is configured to execute a host application, thereby providing the user data; and the UE comprises processing circuitry configured to execute a client application associated with the host application.

### Embodiment H5

A method implemented in a communication system including a host computer, a base station and a user equipment (UE), the method comprising: at the host computer, providing user data; and at the host computer, initiating a transmission carrying the user data to the UE via a cellular network comprising the base station, wherein the base station performs any of the steps of any of the Group G embodiments.

### Embodiment H6

The method of the previous embodiment, further comprising, at the base station, transmitting the user data.

### Embodiment H7

The method of the previous 2 embodiments, wherein the user data is provided at the host computer by executing a host application, the method further comprising, at the UE, executing a client application associated with the host application.

### Embodiment H8

A user equipment (UE) configured to communicate with a base station, the UE comprising a radio interface and processing circuitry configured to perform any of the previous 3 embodiments.

### Embodiment H9

A communication system including a host computer comprising: processing circuitry configured to provide user data; and a communication interface configured to forward user data to a cellular network for transmission to a user equipment (UE), wherein the UE comprises a radio interface and processing circuitry, the UE's components configured to perform any of the steps of any of the Group E embodiments.

### Embodiment H10

The communication system of the previous embodiment, wherein the cellular network further includes a base station configured to communicate with the UE.

### Embodiment H11

The communication system of the previous 2 embodiments, wherein: the processing circuitry of the host computer is configured to execute a host application, thereby providing the user data; and the UE's processing circuitry is configured to execute a client application associated with the host application.

### Embodiment H12

A method implemented in a communication system including a host computer, a base station and a user equipment (UE), the method comprising: at the host computer, providing user data; and at the host computer, initiating a transmission carrying the user data to the UE via a cellular network comprising the base station, wherein the UE performs any of the steps of any of the Group E embodiments.

### Embodiment H13

The method of the previous embodiment, further comprising at the UE, receiving the user data from the base station.

### Embodiment H14

A communication system including a host computer comprising: communication interface configured to receive user data originating from a transmission from a user equipment (UE) to a base station, wherein the UE comprises a radio interface and processing circuitry, the UE's processing circuitry configured to perform any of the steps of any of the Group E embodiments.

### Embodiment H15

The communication system of the previous embodiment, further including the UE.

### Embodiment H16

The communication system of the previous 2 embodiments, further including the base station, wherein the base station comprises a radio interface configured to communicate with the UE and a communication interface configured to forward to the host computer the user data carried by a transmission from the UE to the base station.

### Embodiment H17

The communication system of the previous 3 embodiments, wherein: the processing circuitry of the host computer is configured to execute a host application; and the UE's processing circuitry is configured to execute a client application associated with the host application, thereby providing the user data.

### Embodiment H18

The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

### Embodiment H19

A method implemented in a communication system including a host computer, a base station and a user equipment (UE), the method comprising: at the host computer, receiving user data transmitted to the base station from the UE, wherein the UE performs any of the steps of any of the Group E embodiments.

### Embodiment H20

The method of the previous embodiment, further comprising, at the UE, providing the user data to the base station.

### Embodiment H21

The method of the previous 2 embodiments, further comprising: at the UE, executing a client application, thereby providing the user data to be transmitted; and at the host computer, executing a host application associated with the client application.

### Embodiment H22

The method of the previous 3 embodiments, further comprising: at the UE, executing a client application; and at the UE, receiving input data to the client application, the input data being provided at the host computer by executing a host application associated with the client application, wherein the user data to be transmitted is provided by the client application in response to the input data.

### Embodiment H23

A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group F embodiments.

### Embodiment H24

The communication system of the previous embodiment further including the base station.

### Embodiment H25

The communication system of the previous 2 embodiments, further including the UE, wherein the UE is configured to communicate with the base station.

### Embodiment H26

The communication system of the previous 3 embodiments, wherein: the processing circuitry of the host computer is configured to execute a host application; the UE is configured to execute a client application associated with the host application, thereby providing the user data to be received by the host computer.

### Embodiment H27

A method implemented in a communication system including a host computer, a base station and a user equipment (UE), the method comprising: at the host computer, receiving, from the base station, user data originating from a transmission which the base station has received from the UE, wherein the UE performs any of the steps of any of the Group E embodiments.

### Embodiment H28

The method of the previous embodiment, further comprising at the base station, receiving the user data from the UE.

### Embodiment H29

The method of the previous 2 embodiments, further comprising at the base station, initiating a transmission of the received user data to the host computer.

One or more other embodiments will now be exemplified in the context of NR. In particular, it is proposed for NR to support a “conditional handover” to improve mobility robustness and reduce the handover failure in NR. Most of the concerns regarding conditional handover (CHO) can either be mitigated or controlled by the network so that conditional handover in NR still provide sufficient benefits to justify its support in Rel-15.

In [1],[2],[3] it was observed that conditional handover requires the network to send handover command at an earlier time than actual handover which requires an early measurement report. Furthermore, [2] observes that an early measurement will compromise the reliability and hence it is a drawback of the solution. Although setting a threshold earlier than the actual handover triggering criteria should be studied carefully, it is not very difficult. For example, previous studies in LTE shows an optimal A3 threshold reduces RLF but increases number of HO attempts. A better approach is to issue conditional HO command using such an optimal threshold and perform HO at a later stage. Hence, the number of actual handover attempts will still be low. Also, we observe that since this early report is to be transmitted when the channel condition is better than HO triggering criteria, the reliability of the channel should not be an issue.

Observation 1: Sending early message does not have adverse effect on handover performance and reliability.

On the other hand, sending early message requires triggering additional measurement events along with the current events. One can argue that doing so may increase signalling overhead. However, these additional measurement updates need not to be periodic, but event based. Furthermore, the network should also have the flexibility to set the criterion based on different key performance indicators (KPIs). Hence, the increase in signalling overhead should not necessarily be costly and should be considered as the cost for adding reliability of the service. We also observe alternative solutions such as DC also increases signalling load.

Observation 2: Increase in signalling overhead due to conditional HO can be controlled by the network. It is not very high and is comparable to the signalling overhead of other alternative solutions.

Another concern is raised that conditional HO reduces the network controllability. It was observed in [2] that when the UE sends measurement report upon meeting a normal measurement event (e.g. A2) and it goes missing due to channel condition, UE will try to perform HO based on conditional HO configuration which might not be the intention of source cell anymore. An alternative is proposed to associate an ACK for measurement report. We observe that conditional HO configuration is sent by the source cell to avoid such drastic channel condition and the expected response by the network is that UE will perform handover when the conditional HO criterion is met. Additionally, the source cell can provide the UE with a priority ranking of the target destination cells for prospective HO. Hence, the network will have full control of the UE actions.

Observation 3: Since source cell can prioritize the prospective destination cells for performing HO, conditional handover doesn't necessarily reduce network controllability over the UE actions.

In [3] it was argued that CHO does not reduce/increase handover interruption. While we agree with the numbers presented, however, the feature is not intended for that purpose, but rather to increase the reliability, i.e. to reduce RLF and HOF. Higher HOF rate and RLF rate leads to more RRC connection re-establishments which in turn results in higher delay in terms of interruption times, more signalling and even more measurement efforts from the UE. In NR, RLF and HOF might be more prominent due to deployment in high frequency and spotty coverage due to narrow beamforming. Thus, increasing handover reliability would be even more important in NR. Furthermore, [3] also recognises the prospect of conditional HO to be able to reduce RLF.

Observation 4: The goal of CHO is not to reduce handover interruption, it aims to increase reliability of handover, i.e. reduce RLF and HOF rate in situations where normal HO procedure performance is unsatisfactory.

To ensure better handover performance, conditional handover parameters can be tuned by the network. It was argued in [3] that CHO requires setting parameters that involves prediction from network. However, we observe the fact that network has sufficient amount of statistics available regarding UE, cell conditions (i.e. propagation condition, neighbor cell load etc.) and can take decisions supported by the statistics. A well defined set of rules based on sufficient statistics will improve the decision accuracy without necessarily the need for complex rules. On the other hand, we also believe that these rules need not to be standardized, rather left for specific implementation.

Observation 5: The network can prepare conditional handover parameters using rules based on statistics, just as any network parameter optimization performed in current networks. Decisions based on sufficient statistics would yield better performance.

There are some concerns raised in [3] regarding the increase in the signalling load between the nodeB's compared to the traditional handover. While we accept the fact that certain amount of coordination, hence additional signalling will be required between the nodeB's, we emphasis on the fact that CHO is not to be considered as to replace the baseline HO procedure. It should be considered and deployed as an additional feature/capability of the network to ensure more robust HO performance and possibly solve reliability problems in some certain situation. So a fair comparison of signalling loads between baseline and CHO would be in cases where the network is problematic. In those scenarios, the UE measurement reports or the handover command issued by the network might get lost. Regardless of the reason, the UE will declare HOF and go for RRC-reestablishment procedure. All these procedure requires additional signalling between eNodeBs and UE. Signalling load increase due to CHO should be compared in such cases and in our view, the difference is minimal. Another aspect to be considered is that the network can always try to limit the CHO candidate cells e.g. cells in same gNodeB where in principle there would not be a need for any coordination.

Also concern was raised regarding UE power consumptions if CHO is deployed. We also argue the same as above for this issue. CHO is essentially an additional feature which would be deployed to address problems in some specific cases in the network. Hence UE power consumption will not be affected as predicted in [3].

Observation 6: Signalling load increased by using CHO is comparable to the increase in signalling load in situations where RLF and HOF is high.

To enable CHO, the resources form neighbour cells needs to be reserved and might require updates in some cases. However, as proposed in [1], well defined criteria for CHO will minimize such issues and the UE, source eNodeB and the target eNodeBs can discard configurations without coordination between them if the handover is not performed within some specific time margin.

Observation 7: Well defined criteria for configuration of CHO parameters will essentially reduce the update requirements between the UE and the network.

In [3], it is observed that in LTE, multiple mechanisms has been considered to handle “too late” handovers. While we agree that they still can be explored in NR, we observe that the situation in NR and LTE is different. NR essentially operates on higher frequency than LTE and the problems regarding reliabilities are even greater in NR. Also [3] agrees that with high frequency and narrow beamforming, the possibility of losing the link between UE and network is very high and the probability of HOF increases in NR compared to LTE. We understand in these situations, “too late” handover mechanisms developed for LTE is not sufficient. CHO can have better performance under these situations as the source cell beams may be blocked, but the beams from one of the target cells might still have coverage on the area, hence the UE can handover to that cell and continue. An alternative in these situations are beam management techniques. We agree that proper beam management would likely solve most of the cases but also observe that CHO techniques will provide additional reliability in situations where beam management might prove inadequate e.g. when the functions handling beam management belong to different gNodeBs.

Observation 8: Due to high frequency and narrow beamforming, NR imposes unique situations regarding HOF where the “too late” handover mechanisms might be insufficient. Also, CHO can complement beam management techniques to ensure more reliability.

On the other hand, [3] realizes the benefits of CHO such that it has the potential to reduce handover delay for measurements and handover decisions, can reduce the delay for handover preparation and hence, can reduce the delay compared to the baseline HO procedure. It predicts that a 30% reduction in total handover delay can be achieved. We understand that estimation of reduction of delay is achieved in comparison with normal HO when there is no RLF, HOF involved and believe that under severe network conditions, the improvements would be much higher.

Observation 9: CHO has the advantage of reducing handover delays and decrease RLF probability compared to baseline HO procedure. Thus it can be employed in situations where the network is facing severe conditions

Conditional HO is perceived prospective to have the potential to reduce HO delay and RLF [1],[3],[4], and since normal HO procedure has progressed to a good extent, discussion on conditional HO should continue to progress. Also CHO can be used in conjunction with other tehcniques to ensure more reliability.
[1] R2-1700864, Conditional Handover, Ericsson, RAN2-97, Athens, Greece, 13-17^{th} February 2017
[2] R2-1706711, Further Discussion on Conditional HO, Huawei, HiSilicon, RAN2-98-AH. Qingdao, China, 27-29 Jun. 2017
[3] R2-1703384, Analysis on conditional handover, Huawei, HiSilicon, RAN2-97bis, Spokane, USA, 3-7 Apr. 2017
[4] R2-1706935, Introduction of UE autonomous handover, Samsung, RAN2-98-AH. Qingdao, China, 27-29 Jun. 2017

1-28. (canceled)

29. A method performed by a wireless device configured for use in a wireless communication network, the method comprising:
receiving, from network equipment, signaling that indicates a ranking of target links to which the wireless device is commanded to conditionally perform a link switch.

30. The method of claim 29, further comprising, responsive to detecting fulfillment of one or more conditions for performing a link switch to any of certain ones of the target links, attempting to perform a link switch to one or more of the certain target links in order of the indicated ranking.

31. The method of claim 29, wherein, for each of the target links, the wireless device is commanded to perform a link switch to the target link upon the fulfillment of a respective condition, and wherein the method further comprises:
for each of one or more of the target links, detecting fulfillment of the condition for performing a link switch to that target link; and
attempting to perform a link switch to at least some of the one or more target links for which the condition has been fulfilled, in order of the indicated ranking.

32. The method of claim 29, further comprising:
receiving multiple radio resource control, RRC, connection reconfiguration messages for respective target links, wherein the RRC connection reconfiguration message received for a respective target link commands the wireless device to perform a link switch to the target link upon fulfillment of a respective condition; or
receiving one RRC connection reconfiguration message for the target links, wherein the one RRC connection reconfiguration message commands the wireless device to perform a link switch to any of the target links for which the same condition is fulfilled.

33. The method of claim 29, further comprising transmitting, to the network equipment, a measurement report for each of the target links, and wherein the signaling is received after said transmitting.

34. The method of claim 29, wherein the link switch is a conditional handover that is to be performed upon the wireless device detecting fulfilment of one or more conditions.

35. A method performed by network equipment configured for use in a wireless communication network, the method comprising:
transmitting to a wireless device signaling that indicates a ranking of target links to which the wireless device is commanded to conditionally perform a link switch.

36. The method of claim 35, further comprising:
responsive to receiving a measurement report from the wireless device, determining a set of target links to evaluate as candidates for commanding the wireless device to conditionally perform a link switch;
determining a ranking of the target links in the set;
deciding, based on the determined ranking, to which of the target links in the set the network equipment is to command the wireless device to conditionally perform a link switch; and
transmitting to the wireless device signaling, in accordance with said deciding, indicating target links to which the wireless device is commanded to conditionally perform a link switch.

37. The method of claim 36, further comprising:
before determining the ranking of the target links in the set, preparing each of the target links in the set for the link switch by transmitting a link switch request to each of one or more network equipment providing the target links; and
after said deciding based on the determined ranking, transmitting release signaling to any network equipment providing a target link to which the wireless device is not to be commanded to perform a conditional link switch, the release signaling indicating to release any resources prepared for a link switch to the target link.

38. The method of claim 35, comprising determining the ranking of the target links based on one or more of:
for each of one or more of the target links, a rank of the target link received from network equipment providing that target link;
current or expected loading on each of the target links;
a type or coverage area size of each of the target links;
statistics describing historical success or failure of link switches to each of the target links;
a type of random access resources provided by each of the target links; and
a validity timer of resources provided by each of the target links.

39. The method of claim 35, wherein the link switch is a conditional handover that is to be performed upon the wireless device detecting fulfilment of one or more conditions.

40. A wireless device configured for use in a wireless communication network, the wireless device comprising:
communication circuitry; and
processing circuitry configured to receive from network equipment signaling that indicates a ranking of target links to which the wireless device is commanded to conditionally perform a link switch.

41. The wireless device of claim 40, wherein the processing circuitry is further configured to, responsive to detecting fulfillment of one or more conditions for performing a link switch to any of certain ones of the target links, attempt to perform a link switch to one or more of the certain target links in order of the indicated ranking.

42. The wireless device of claim 40, wherein, for each of the target links, the wireless device is commanded to perform a link switch to the target link upon the fulfillment of a respective condition, and wherein the processing circuitry is further configured to:
for each of one or more of the target links, detect fulfillment of the condition for performing a link switch to that target link; and
attempt to perform a link switch to at least some of the one or more target links for which the condition has been fulfilled, in order of the indicated ranking.

43. The wireless device of claim 42, wherein the processing circuitry is configured to attempt to perform a link switch by:
attempting to perform a link switch to a lower ranked target link only after an attempt to perform a link switch to a higher ranked target link has failed; or
attempting to perform a link switch to a lower ranked target link after attempting to perform a link switch to a higher ranked target link, but before that attempt to perform a link switch to the higher ranked target link is deemed to have succeeded or failed.

44. The wireless device of claim 40, wherein the processing circuitry is further configured to:
receive multiple radio resource control, RRC, connection reconfiguration messages for respective target links, wherein the RRC connection reconfiguration message received for a respective target link commands the wireless device to perform a link switch to the target link upon fulfillment of a respective condition; or
receive one RRC connection reconfiguration message for the target links, wherein the one RRC connection reconfiguration message commands the wireless device to perform a link switch to any of the target links for which the same condition is fulfilled.

45. The wireless device of claim 40, wherein the processing circuitry is further configured to transmit, to the network equipment, a measurement report for each of the target links, and wherein the signaling is received after said transmitting.

46. The wireless device of claim 40, wherein the signaling indicating the ranking of the target links to which the wireless device is commanded to conditionally perform a link switch comprises signaling indicating a ranking of a set of potential target links and signaling indicating which of the potential target links are target links to which the wireless device is commanded to conditionally perform a link switch.

47. The wireless device of claim 40, wherein the signaling:
implicitly indicates the ranking of target links by indicating a list of target links, with the target links ordered in the list according to the ranking; or
explicitly indicates the ranking of target links by indicating a list of target links and indicating a rank for each target link in the list.

48. The wireless device of claim 40, wherein the link switch is a conditional handover that is to be performed upon the wireless device detecting fulfilment of one or more conditions.

49. Network equipment configured for use in a wireless communication network, the network equipment comprising:
communication circuitry; and
processing circuitry configured to transmit to a wireless device signaling that indicates a ranking of target links to which the wireless device is commanded to conditionally perform a link switch.

50. The network equipment of claim 49, wherein the processing circuitry is further configured to:
responsive to receiving a measurement report from the wireless device, determine a set of target links to evaluate as candidates for commanding the wireless device to conditionally perform a link switch;
determine a ranking of the target links in the set;
decide, based on the determined ranking, to which of the target links in the set the network equipment is to command the wireless device to conditionally perform a link switch; and
transmit to the wireless device signaling, in accordance with said deciding, indicating target links to which the wireless device is commanded to conditionally perform a link switch.

51. The network equipment of claim 50, wherein the processing circuitry is further configured to:
before determining the ranking of the target links in the set, prepare each of the target links in the set for the link switch by transmitting a link switch request to each of one or more network equipment providing the target links; and
after said deciding based on the determined ranking, transmit release signaling to any network equipment providing a target link to which the wireless device is not to be commanded to perform a conditional link switch, the release signaling indicating to release any resources prepared for a link switch to the target link.

52. The method of claim 51, wherein the processing circuitry is further configured to determine the ranking of the target links in the set based, at least in part, on information received from each of the one or more network equipment in response to the link switch request transmitted to that network equipment.

53. The network equipment of claim 49, wherein the processing circuitry is configured to determine the ranking of the target links based on one or more of:
for each of one or more of the target links, a rank of the target link received from network equipment providing that target link;
current or expected loading on each of the target links;
a type or coverage area size of each of the target links;
statistics describing historical success or failure of link switches to each of the target links;
a type of random access resources provided by each of the target links; and
a validity timer of resources provided by each of the target links.

54. The network equipment of claim 49, wherein the link switch is a conditional handover that is to be performed upon the wireless device detecting fulfilment of one or more conditions.
